(19) United States
(12) Patent Application Publication
(10) Pub. No.: US 2019/0072684 A1
(43) Pub. Date: Mar. 7, 2019

(54) SEISMIC MONITORING SYSTEM AND METHOD FOR CARRYING OUT THE SEISMIC MONITORING USING SAID MONITORING SYSTEM

(71) Applicant: AREA PREFABBRICATI S.P.A., Casalgrande (RE) (IT)

(72) Inventor: Emanuel MANFREDINI, Casalgrande (RE) (IT)

(21) Appl. No.: 15/577,529

(22) PCT Filed: May 27, 2016
(86) PCT No.: PCT/IB2016/053130

§ 371 Date: Nov. 28, 2017

(30) Foreign Application Priority Data
May 28, 2015 (IT) 102015000018996

(51) Int. Cl. G01V 1/00; G01M 5/00; G01V 1/16; G01P 15/125; G01P 15/03

(52) U.S. Cl. CPC G01V 1/003; G01M 5/0008; G01P 15/032; G01P 15/125; G01V 1/164

(57) ABSTRACT

The invention falls within the field of the techniques for manufacturing seismic monitoring systems and is applicable to structures related to civil engineering.

A seismic monitoring system (1) is implemented by the method according to the present invention which includes a set of equipment (such as accelerometric sensors (2a, 2b) and an acquisition unit (3); the accelerometric sensors (2a, 2b) measure at predetermined instants, with a predetermined frequency, the acceleration values of the points of the structure (11) at which said accelerometric sensors are positioned; each of the one or more acquisition units (3) comprises, in addition to a RAM memory, a mass memory in which at least part of the data measured by the accelerometric sensors (2a, 2b) connected to said acquisition unit and transmitted by said accelerometric sensors to said acquisition unit is stored; said seismic monitoring system (1), if said structure (11) is subjected to seismic actions, is adapted to be used to detect, after the seismic event, by processing the measured data, in addition to the accelerations, also the displacements of the points of said structure (11) at which the accelerometric sensors (2a, 2b) are positioned.

Monitoring systems adapted to measure displacements and rotations of structural elements forming part of a structure are known in the art. Among these monitoring systems, seismic monitoring systems are known which are adapted to identify the behavior of a structure when it is subjected to seismic actions. In particular, seismic monitoring systems are known which are adapted to provide information to assess the extent of the damage that a structure has undergone as a result of a seismic event.

The latter seismic monitoring systems usually comprise sensors placed at significant points of the structure, a data collection unit connected to the sensors and a unit that processes data and communicates with the “outside” of the structure.

In some cases, the seismic monitoring systems according to the prior art comprise data processing units which are placed inside the building monitored; this implies that such units must be provided with “significant intelligence” and computational capability; hence, the costs of such monitoring systems are often considerable and often are not acceptable to monitor “current” type buildings.

In other cases, the seismic monitoring system according to the prior art transmits the measured data to a remote electronic processor with which such seismic monitoring system communicates; specific software is present in said remote electronic processor, related to the equipment installed in the building to be monitored; in such remote electronic processor, most of the times, a ready structural model is also present set up for the input of data resulting from the measurements of the equipment installed in said building.

Such seismic monitoring systems often send messages also in the synthetic form of signals which may consist, for example, of a yellow light, a red light and a green light which, according to the various seismic monitoring systems used, take meanings more or less exactly related to the concepts of “no damage”, “light damage”, “strong damage”.

Such seismic monitoring systems for highlighting the structural damage after a seismic event have been installed in a variety of constructions, usually of considerable importance, such as tall buildings, bridges, etc.

Seismic monitoring systems are also present in the prior art which are adapted to measure in real time the effects of a seismic action and compare such values with predetermined threshold values, corresponding to limit states of the structure or some of its elements.

The seismic monitoring systems mentioned above have allowed and allow knowing important data concerning the damages suffered by the buildings (and structures) monitored; however, they may exhibit the following drawbacks.

Very often, considering also the most advanced seismic monitoring systems of the prior art, it is problematic, if not impossible, to implement an automatic mechanism that provides for having the “permission” to be able to immediately reuse the building in real-time.

In many cases, the “immediacy” (as strictly defined) is not even necessary, nor is it required.

If seismic monitoring systems are adopted which are adapted to “automatically” compare the measured and calculated values (such as the displacement values of the ends of a pillar) with predetermined threshold values introduced at the time of installation of the seismic monitoring system by the engineer designer of the structure, a study and a particularly accurate calculation are required in order to predict what the seismic response of the structure will be to hypothetical design earthquakes and the threshold values of the various limit states to be considered are to be determined. It is clear that such prior study of the structure requires significant activity, and therefore costs; this applies mainly in the case of an existing structure, wherein many cases the engineer who has to calculate the aforesaid threshold values was not the designer of the structure at the time of its construction.

Also, it is believed that, in any case, the performance in terms of identification of the damage after a seismic event, which may characterize a monitoring system, are in many cases not directly and “automatically” usable, since the synthetic and final opinion of an engineer who checks the situation on-site is always necessary, as part of an overview of the structure and the building as a whole.

In the light of the above, it is clear that in many current cases the application of seismic monitoring systems according to the prior art involves the execution of activities, and therefore the use of resources, which are often, at least according to the current market and culture, unlikely to be accepted in the current construction practice.

In other cases, the performance required of the seismic monitoring system (such as that required to identify the structural damage) still do not correspond to certain requirements which occur in practice.

An object of the present invention is to provide a monitoring system which provides the verifier engineer with the displacement value of significant points of the structure, from the knowledge of which the same engineer may have useful information regarding the dynamic response of said structure.

Another object of the present invention is to provide a seismic monitoring system that is cost-effective, and which can therefore concretely spread in the current construction practice and can be installed at the structures of many buildings.

These and other objects are achieved by the seismic monitoring system, object of the present invention, and by the method for carrying out the seismic monitoring using said monitoring system, also object of the present invention.

The features and the advantages of the present invention will become more apparent from the following description of three embodiments thereof, given by way of non-limiting example in the accompanying drawings, in which:

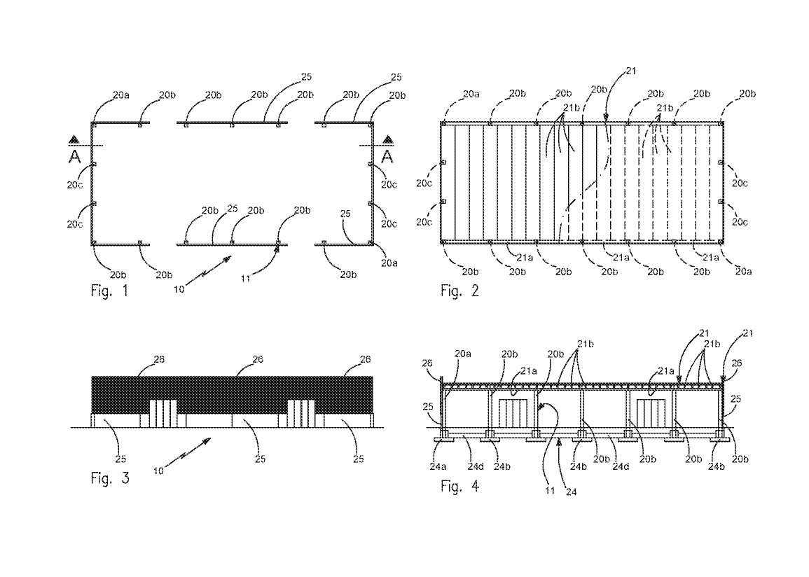

FIG. 1 shows a plan view of the ground floor of a prefabricated industrial building, on the structure of which a seismic monitoring system obtained according to the present invention, has been installed according to a first embodiment;

FIG. 2 shows, in the same scale of FIG. 1, a partially top and partially cross-sectional view of the covering deck of the prefabricated industrial building in FIG. 1;

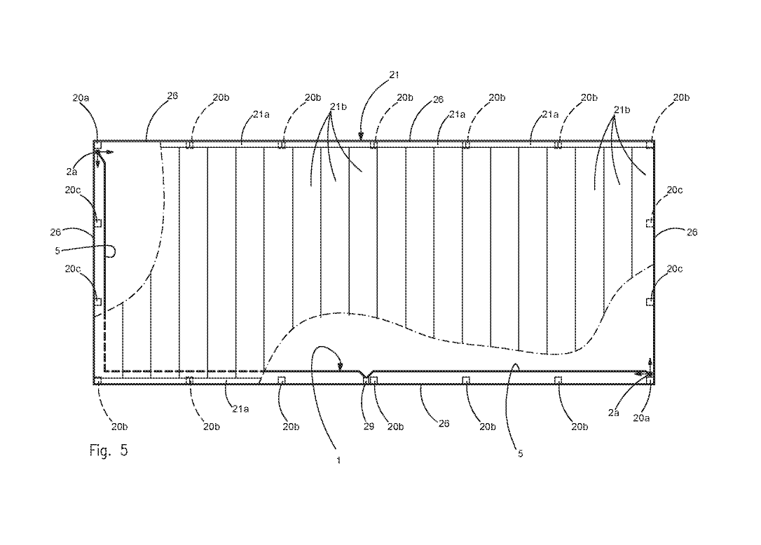

FIG. 3 shows, in the same scale of FIG. 1, a longitudinal perspective view of the prefabricated industrial building in FIG. 1;

FIG. 4 shows, in the same scale of FIG. 1, the section along the straight line A-A in FIG. 1;

FIG. 5 shows, in a larger scale than that in FIG. 1, a partially top and partially cross-sectional view of the covering deck of the prefabricated industrial building in FIG. 1; FIG. 5 also shows part of the circuit diagram of the seismic monitoring system installed at the structure of the prefabricated industrial building in FIG. 1;

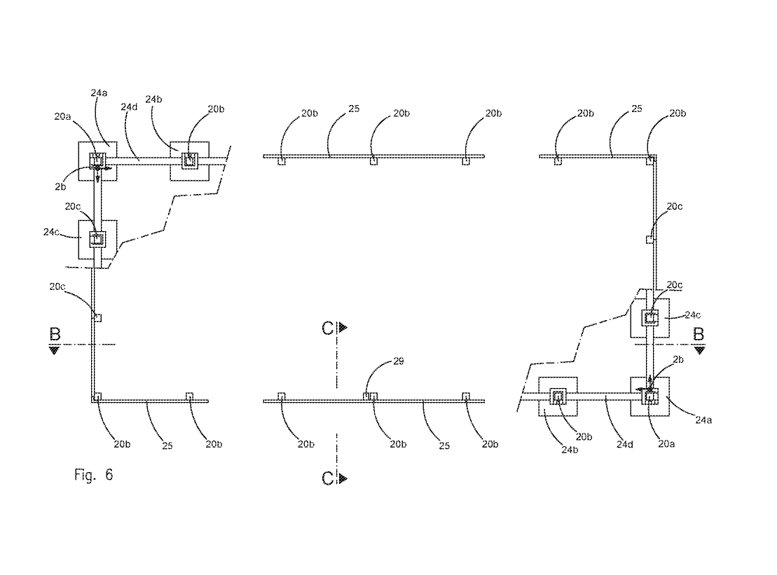

FIG. 6 shows, in the same scale of FIG. 5, a partially top and partially cross-sectional view of the ground floor of the prefabricated industrial building in FIG. 1 and part of the foundations;

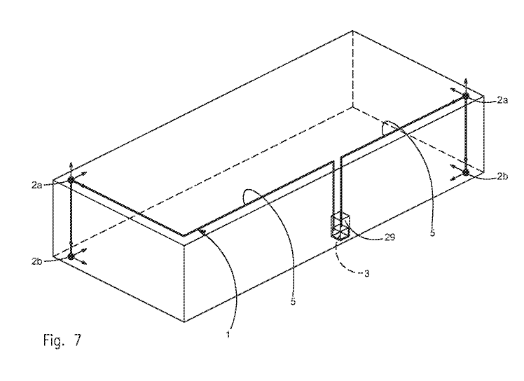

FIG. 7 shows an axonometric view of the overall circuit diagram of the seismic monitoring system installed at the structure of the prefabricated industrial building in FIG. 1;

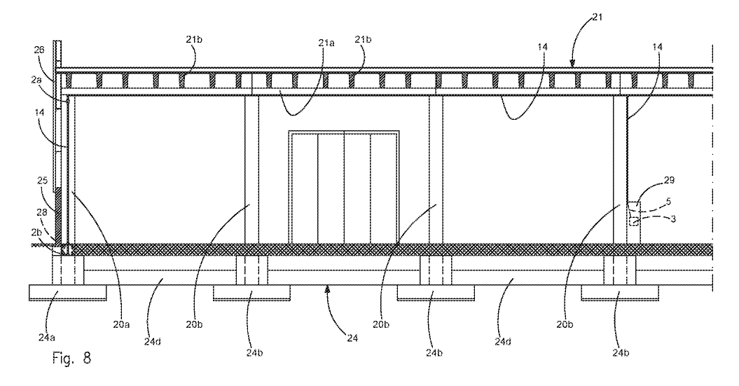

FIG. 8 shows, in a larger scale than that in FIG. 6, part of the section along the straight line B-B in FIG. 6;

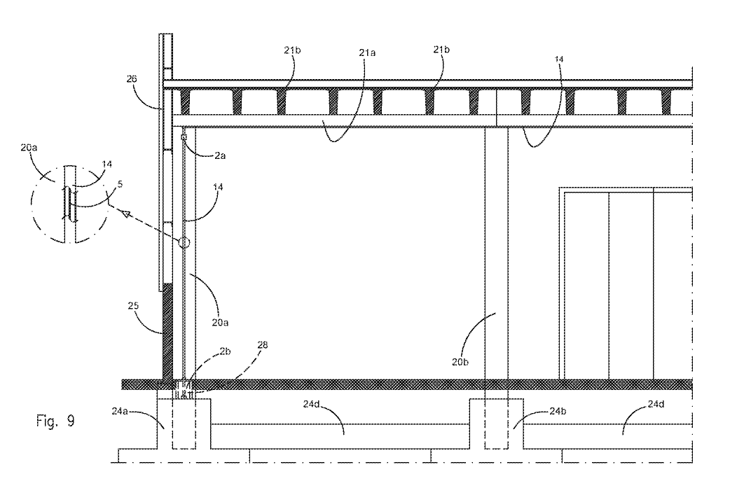

FIG. 9 shows, in a larger scale than that in FIG. 8, a detail of FIG. 8;

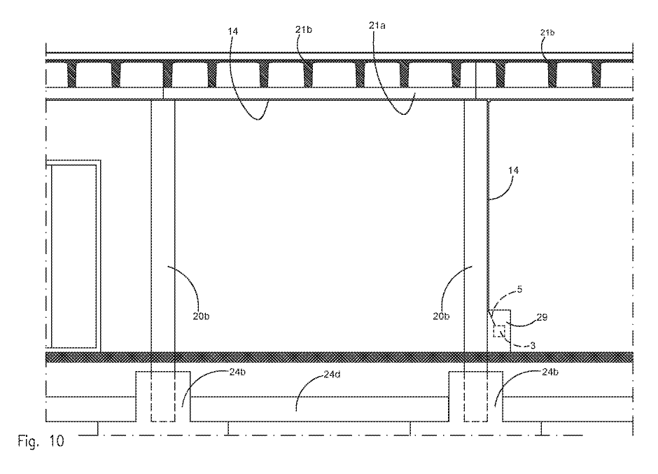

FIG. 10 shows, in the same scale of FIG. 9, another detail of FIG. 8;

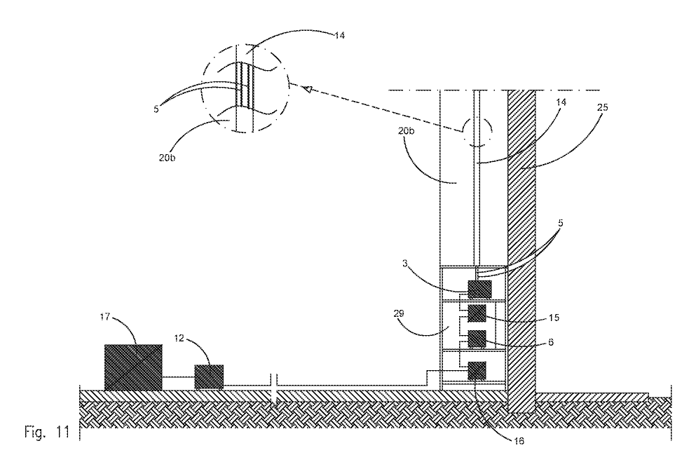

FIG. 11 shows, in a larger scale than that in FIG. 6, the section along the straight line C-C in FIG. 6 and a diagram of a part of the equipment of the seismic monitoring system installed at the structure of the prefabricated industrial building in FIG. 1;

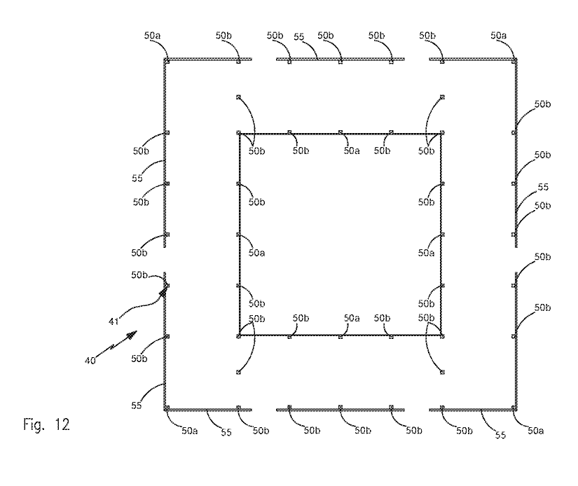

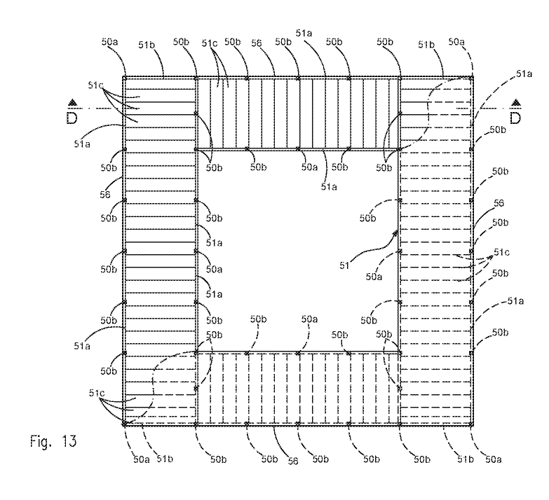

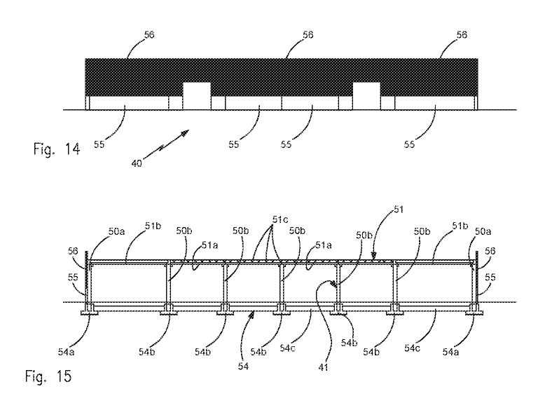

FIG. 12 shows a plan view of the ground floor of a prefabricated industrial building, on the structure of which a seismic monitoring system obtained according to the present invention, has been installed according to another embodiment;

FIG. 13 shows, in the same scale of FIG. 12, a partially top and partially cross-sectional view of the covering deck of the prefabricated industrial building in FIG. 12;

FIG. 14 shows, in the same scale of FIG. 12, a longitudinal perspective view of the prefabricated industrial building in FIG. 12;

FIG. 15 shows, in the same scale of FIG. 12, the section along the straight line D-D in FIG. 13;

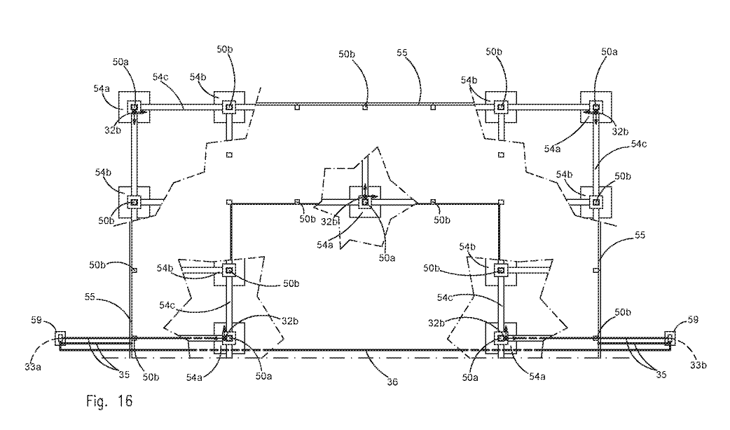

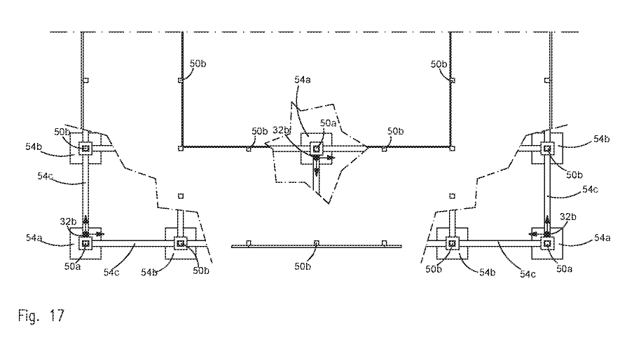

FIG. 16 shows, in a larger scale than that in FIG. 12, a partially plan and partially cross-sectional view of a portion of the ground floor of the prefabricated industrial building in FIG. 12 and part of the foundations; FIG. 16 also shows part of the circuit diagram of the seismic monitoring system installed at the structure of the prefabricated industrial building in FIG. 12;

FIG. 17 shows, in the same scale of FIG. 16, a partially plan and partially cross-sectional view of the remaining portion of the ground floor of the prefabricated industrial building in FIG. 12 and part of the foundations;

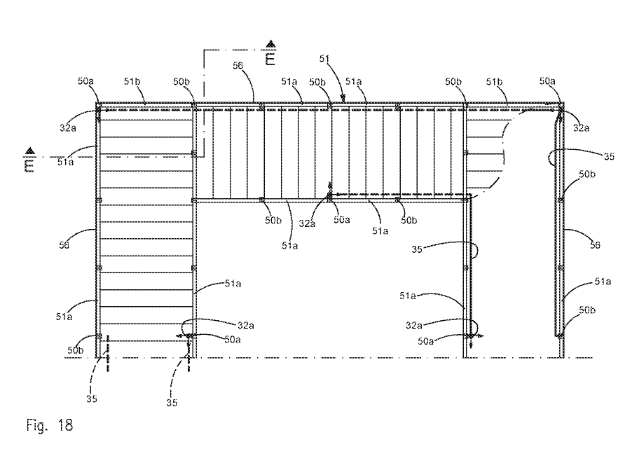

FIG. 18 shows, in the same scale of FIG. 16, a partially top and partially cross-sectional view of a portion of the covering deck of the prefabricated industrial building in FIG. 12; FIG. 18 also shows part of the circuit diagram of the seismic monitoring system installed at the structure of the prefabricated industrial building in FIG. 12;

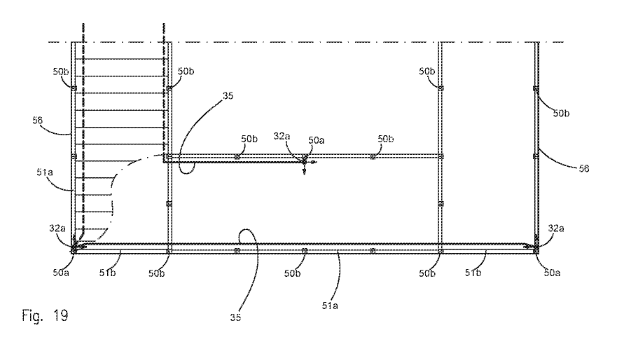

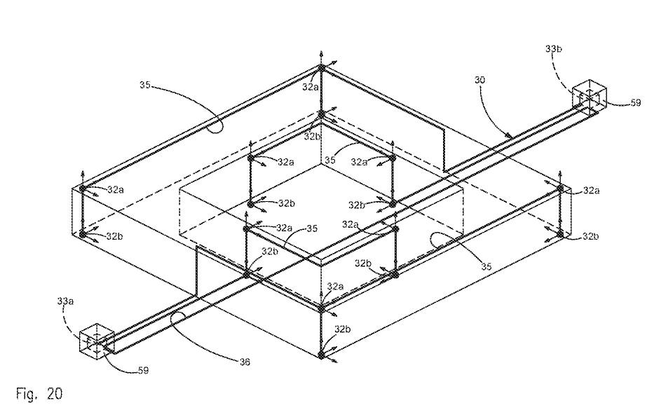

FIG. 19 shows, in the same scale of FIG. 18, a partially top and partially cross-sectional view of the remaining portion of the covering deck of the prefabricated industrial building in FIG. 12; FIG. 19 also shows part of the circuit diagram of the seismic monitoring system installed at the structure of the prefabricated industrial building in FIG. 12;

FIG. 20 shows an axonometric view of the overall circuit diagram of the seismic monitoring system installed at the structure of the prefabricated industrial building in FIG. 12;

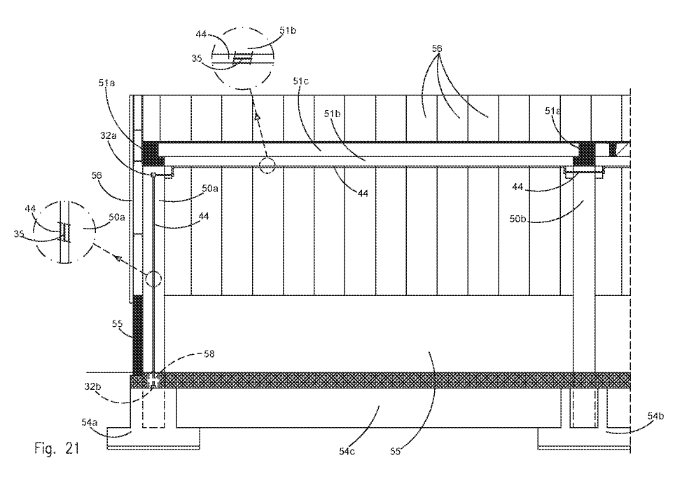

FIG. 21 shows, in a larger scale than that in FIG. 18, the section along the straight line E-E in FIG. 18;

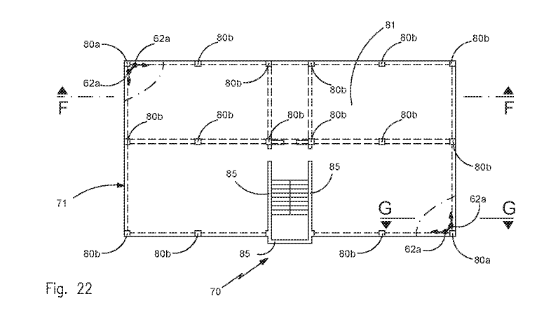

FIG. 22 shows a plan view, with two details in cross-section, of the covering horizontal element (third horizontal element) of the structure of an office building, at which a seismic monitoring system obtained according the present invention has been installed, according to a further embodiment;

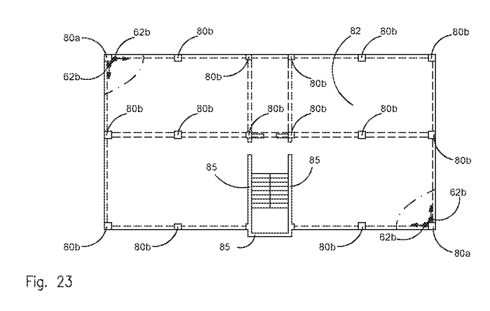

FIG. 23 shows, in the same scale of FIG. 22, a plan view with two details in cross-section of the second horizontal element of the structure of the building in FIG. 22;

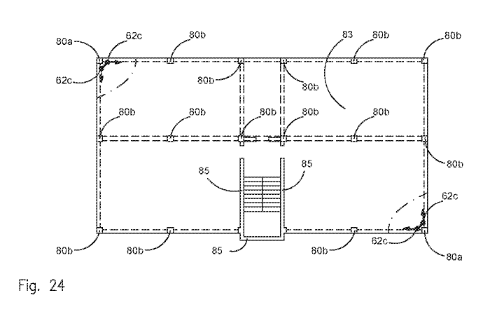

FIG. 24 shows, in the same scale of FIG. 22, a plan view with two details in cross-section of the first horizontal element of the structure of the building in FIG. 22;

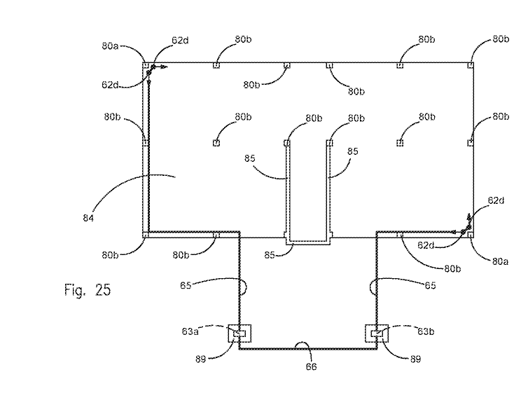

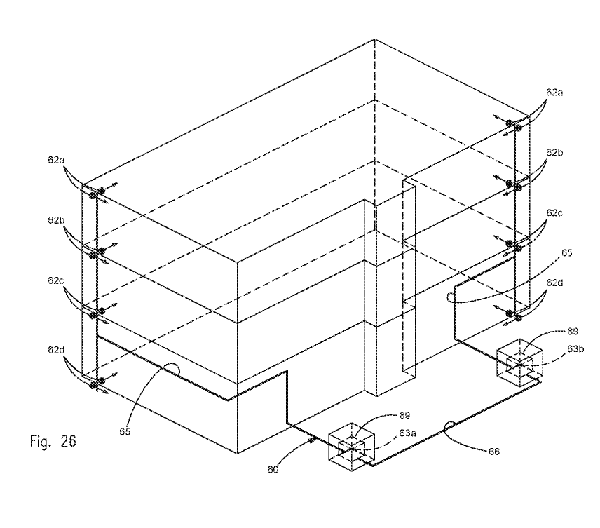

FIG. 25 shows, in the same scale of FIG. 22, a plan view of the foundation plane of the structure of the building in FIG. 22; FIG. 25 also shows part of the circuit diagram of the seismic monitoring system installed at the structure of the building in FIG. 22;

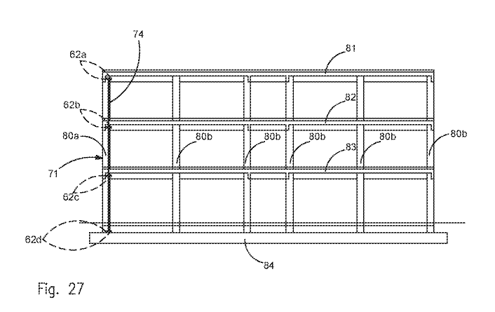

FIG. 26 shows an axonometric view of the overall circuit diagram of the seismic monitoring system installed at the structure of the building in FIG. 22;

FIG. 27 shows, in the same scale of FIG. 22, the section along the straight line F-F in FIG. 22;

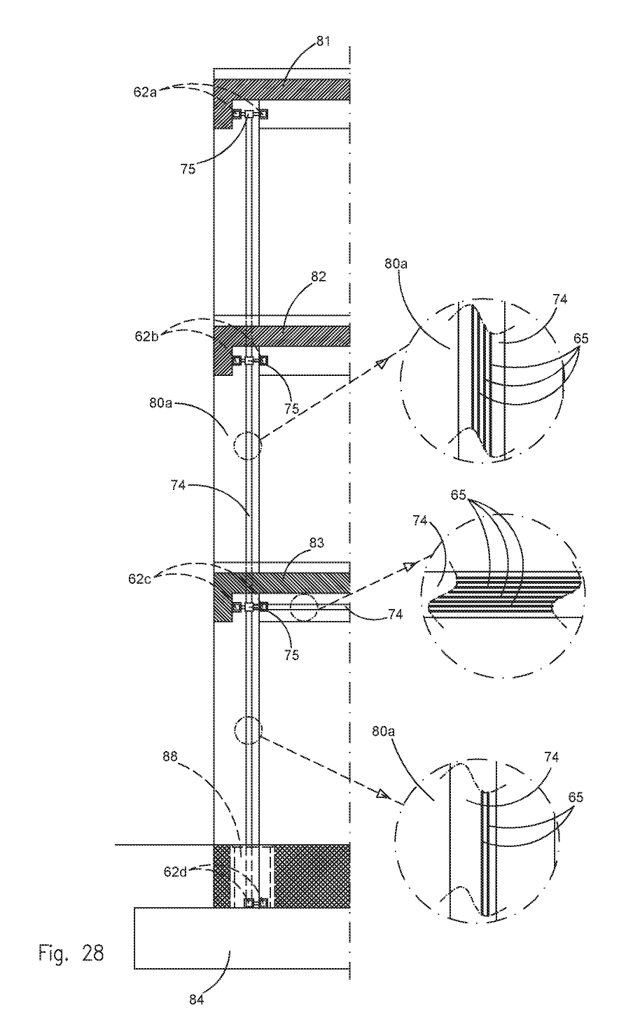

FIG. 28 shows, in a larger scale than that in FIG. 22, the section along the straight line G-G in FIG. 22.

Referring to FIGS. 1, 2, 3, 4, 5, 6, 7, 8, 9, 10 and 11, the seismic monitoring system 1 obtained according to the present invention is described, according to a first embodiment thereof. The seismic monitoring system 1 is installed at a structure 11 of a new industrial building 10; structure 11 comprises structural reinforced concrete and prestressed reinforced concrete elements and is such that brittle failure mechanisms are prevented therein and only ductile failure mechanisms are possible. Structure 11 includes eighteen prefabricated reinforced concrete pillars 20a, 20b, 20c, a covering deck 21 and foundations 24 made of reinforced concrete cast on site. The covering deck 21 includes prefabricated prestressed reinforced concrete beams 21a and prefabricated prestressed reinforced concrete roof tiles 21b.

The pillars bearing the covering deck 21 and which constitute the structural elements in charge of withstanding the seismic actions are the fourteen pillars 20a, 20b; for this reason, reference is only made to pillars 20a, 20b hereinafter. Building 10 is located in a seismic zone. The roof tiles 21b, which are of TT type, are mutually connected and are connected to beams 21a that hold support them in such a way as to form a deck that can be considered as rigid in its plane. Foundations 24 comprise “cup” plinths 24a, 24b, 24c and connecting beams 24d which substantially prevent the horizontal relative displacements between the above plinths 24a, 24b, 24c. A reinforced concrete slab is also present which constitutes the industrial flooring of building 10.

In the case of structure 11, it is reasonable to consider both foundation 24 and the covering deck 21 rigid in their plane, where tiles 21b are connected to beams 21a and are also mutually connected at their wings.

It is noted that the structural elements that form structure 11 are mutually connected according to the resistance hierarchy criteria; the above-mentioned structural elements and the connections between the structural elements are made with such criteria and construction details that brittle failures are prevented, thus ductile failure mechanisms only being possible.

The curtain wall, on the four sides of building 10, comprises horizontal reinforced concrete panels 25, which constitute a first band of the curtain wall, and sandwich panels 26, consisting of two metal sheets and interposed insulating layer, placed above said first band; the sandwich panels 26 are provided with appropriate metal structures not shown, for simplicity, in the figures.

The seismic monitoring system 1 includes:
four accelerometric sensors 2a, 2b (and therefore a plurality of accelerometric sensors 2a, 2b) positioned at significant points of structure 11; the two accelerometric sensors 2a are positioned at the intrados of the covering deck 21; the two accelerometric sensors 2b are positioned at foundations 24; two accelerometric sensors 2a, 2b are positioned at one of the two pillars 20a; the other two accelerometric sensors 2a, 2b are positioned at the other pillar 20a;
an acquisition unit 3, to which the accelerometric sensors 2a, 2b are connected; the acquisition unit 3 continuously receives data from the accelerometric sensors 2a, 2b.

The seismic monitoring system 1, once installed at structure 11 and once activated, functions continually, except for the pauses due to maintenance or replacement of components, for the entire useful lifetime of structure 11.

The accelerometric sensors 2a, 2b measure, with a predetermined frequency, the accelerations of the points at which the accelerometric sensors 2a, 2b themselves are positioned (such points are significant points of structure 11). The acquisition unit 3 synchronizes the measurements of all the four accelerometric sensors 2a, 2b comprised in the seismic monitoring system 1, indicating to the four accelerometric sensors 2a, 2b the instants at which they must carry out the measurements (of acceleration).

The acquisition unit 3 comprises, in addition to a RAM memory, a mass memory in which part of the data measured by the accelerometric sensors 2a, 2b and transmitted by said accelerometric sensors 2a, 2b to the acquisition unit 3 itself is stored; in said mass memory, the instants are also stored at which such data has been measured; said mass memory is extractable. Such mass memory consists of a USB key (flash memory with USB interface) provided with adequate memory capacity.

The acquisition unit 3 preserves, in its mass memory, only the most recent data, canceling the less recent data before introducing new data; in this way, the acquisition unit 3 maintains its mass memory updated.

The acquisition unit 3 also provides the necessary electrical energy to the accelerometric sensors 2a, 2b (which are connected to it).

The seismic monitoring system 1, if structure 11 is subjected to seismic actions, is adapted to be used so to be able to identify, in addition to the accelerations, also the displacements of the points of structure 11 at which the accelerometric sensors 2a, 2b are positioned; said displacements are obtained by means of processing, executed after the seismic event, of the acceleration measurements carried out by the accelerometric sensors 2a, 2b; such processing is carried out by means of an external computer that is not part of the seismic monitoring system 1 and which is situated outside the monitored structure 11.

Said external computer carries out the above processing once the data retrieved by extracting the mass memory of the acquisition unit 3 has been introduced in the external computer itself.

It is noted that the above data processing is carried out after the application of the dynamic actions to structure 11 due to a seismic event; said data processing substantially consists in the calculation of the displacements of said significant points of structure 11 at which the accelerometric sensors 2a, 2b are installed; the displacements of the significant points of structure 11 are obtained, once the accelerations (the acceleration are known as they are measured by the accelerometric sensors 2a, 2b) and the instants at which they were measured are known, by carrying out a dual integration in the time domain of the time histories of the accelerations. Knowing the displacement values of the significant points of structure 11, the relative displacements between the top and the base of pillars 20a, and therefore the drifts of pillars 20a themselves are then calculated.

The hypothesis of non-deformability in its plane of the covering deck 21 and of foundations 24, in fact, knowing the displacements of the (significant) points in which the accelerometric sensors 2a, 2b are positioned, allows easily calculating also the displacements at the top and at the base of pillars 20b (at which no accelerometric sensors 2a, 2b are installed).

As is known, in general, the drift between the horizontal elements of a “frame” structure and therefore the drift of the pillars constitutes one of the main parameters by which it is possible to identify the state of damage suffered by the structure due to a seismic action.

The acquisition unit 3 and the accelerometric sensors 2a, 2b are connected to one another by means of various data transmission lines. In particular, the acquisition unit 3 and the accelerometric sensors 2a, 2b are connected to one another by means of a CAN bus network (CAN stands for: Controller Area Network) comprising two CAN bus lines. An accelerometric sensor 2a and an accelerometric sensor 2b are connected on each of the above two CAN bus lines, one after the other; each of the two CAN bus lines is then connected to the acquisition unit 3.

Each accelerometric sensor 2a, 2b is a triaxial accelerometric sensor; that is, each accelerometric sensor 2a, 2b measures the acceleration in three mutually orthogonal directions.

Each accelerometric sensor 2a, 2b comprises two triaxial accelerometers of capacitive type, a main microprocessor, a control microprocessor, a temperature sensor, a CAN bus driver, an error signaling circuit, a clock signal input circuit, two connectors adapted to connect the accelerometric sensor 2a, 2b considered to the CAN bus network and to the other data transmission lines, a power supply unit and a containment element, inside which all the above-mentioned components are positioned. Within the containment element, a synthetic filling resin is also present which makes all the components present inside said containment element a single “solid” element.

Said main microprocessor, among other things, converts the analog signals received from the two accelerometers (forming part of the above accelerometric sensor 2a, 2b) into digital data and carries out controls at least related to the functioning of the above two accelerometers. The two accelerometers comprised in each accelerometric sensor 2a, 2b, are of MEMS (Micro Electro-Mechanical Systems) type. As is known, MEMS include mechanical and electrical microsystems, integrated on the same base material; the electrical and mechanical microsystems are made in miniature form.

The two accelerometers and the temperature sensor are connected to the main microprocessor.

The control microprocessor is connected to the main microprocessor and to the error signaling circuit.

In each accelerometric sensor 2a, 2b, the power supply unit is connected to all the components of the accelerometric sensor 2a, 2b to which it supplies the necessary electrical energy.

Each of the two accelerometric sensors 2a is integral to the relative pillar 20a; each of the two accelerometric sensors 2b is installed at the extrados of plinth 24a (of the relative pillar 20a) and is placed in the proximity of said pillar 20a. Each of the two accelerometric sensors 2b is inserted into a pit 28 which is devoid of the bottom and of a side wall and which is provided with a lid.

The acquisition unit 3 comprises a microprocessor, a user communication system, a RAM memory, a mass memory in which part of the data transmitted by the accelerometric sensors 2a, 2b is stored, a clock generator, a USB bus driver for the management of the mass memory, a circuit for the input of the error messages from the accelerometric sensors 2a, 2b, connectors for connection with two CAN bus lines and with other data transmission lines, and in particular with data transmission lines for the possible connection with other acquisition units (in the case of the seismic monitoring system 1, such connectors are not used), a transformer and a power supply unit; said mass memory is extractable. In the case of the acquisition unit 3, the user communication system includes a touch screen, along with the components required for its operation.

It is noted that the acquisition unit 3 acquires the data transmitted by the accelerometric sensors 2a, 2b and stores part of the acquired data to its mass memory (according to methods and criteria outlined hereinafter).

The acquisition unit 3 also has the function of clock generator, so that it scans the instants at which the accelerometric sensors 2a, 2b must carry out the measurements of the accelerations. In order to communicate, to the accelerometric sensors 2a, 2b, the instants at which they must carry out the measurements of the accelerations, the acquisition unit 3 uses signals that are sent by the acquisition unit 3 itself to the accelerometric sensors 2a, 2b by means of a specific transmission line called “synchronization line”.

It is noted that in this way, the simultaneous measurement of the accelerations, at predetermined instants, carried out by all the accelerometric sensors 2a, 2b connected to the acquisition unit 3 is possible.

Considering each of the four accelerometric sensors 2a, 2b, the following is noted. The main microprocessor forming part of the accelerometric sensor 2a, 2b considered receives the analog signals from the two accelerometers comprised in the above accelerometric sensor 2a, 2b, samples these analog signals according to a predetermined frequency indicated by the acquisition unit 3 and converts them into digital data; moreover, the main microprocessor processes these digital data. It is noted that in some cases (see hereinafter), the main microprocessor, in a generic instant t (during the service lifetime of the accelerometric sensor 2a, 2b considered), samples and takes into consideration only the signals transmitted by one of the two accelerometers (reference accelerometer).

A suitable sampling frequency is equal to 1000 Hz.

The data processing carried out by the main microprocessor also includes the correction [compensation] of the measurements of the reference accelerometer as a function of the temperature of the accelerometric sensor 2a, 2b at the time of measurement; this temperature is detected by the temperature sensor comprised in the accelerometric sensor 2a, 2b considered that transmits it to the main microprocessor. The main microprocessor then sends such data to the acquisition unit 3 by means of the CAN bus network. It is noted that the main microprocessor sends the data over the CAN bus network via the CAN bus driver mentioned above. The above main microprocessor then periodically controls the functioning of the two accelerometers and activates and executes the control procedures relating to the accelerometric sensor 2a, 2b considered. If one of said two accelerometers stops functioning properly, the above main microprocessor signals such malfunction to the acquisition unit 3.

In each of the accelerometric sensors 2a, 2b, the control microprocessor exchanges signals with the above main microprocessor to check the proper functioning thereof; if the signals exchanged between the main microprocessor and the control microprocessor do not conform to what they should, then an error signal is transmitted by the accelerometric sensor 2a, 2b, and more specifically by the above error signaling circuit, which is received by the acquisition unit 3; this error signal indicates that the accelerometric sensor 2a, 2b is out of service; a specific data transmission line is used for the transmission of the above error signal.

According to a first measurement strategy, in each accelerometric sensor 2a, 2b, the main microprocessor (comprised in the accelerometric sensor 2a, 2b considered) takes into consideration, at each instant at which the acceleration is measured, the measurements carried out by the two accelerometers comprised therein, processing them in order to obtain the most exact possible acceleration values.

According to a second measurement strategy, in each accelerometric sensor 2a, 2b, the main microprocessor (comprised in the accelerometric sensor 2a, 2b considered) takes into consideration, at each instant at which the acceleration is measured, the measurements carried out by only one of the two accelerometers (comprised in the accelerometric sensor 2a, 2b considered); in this case, one of the two accelerometers is considered the reference accelerometer and the other is considered the reserve accelerometer.

This second measurement strategy is discussed hereinafter.

The four accelerometric sensors 2a, 2b and the acquisition unit 3 are mutually connected by cable; it is noted that there are two cables 5; one cable 5 is connected to an accelerometric sensor 2b, to an accelerometric sensor 2a (both placed at one of the two pillars 20a and at the relative plinth 24a) and to the acquisition unit 3, the other cable 5 is connected to the other two accelerometric sensors 2a, 2b (placed at the other pillar and at the relative plinth 24a) and to the acquisition unit 3. The two cables 5 are inserted into cable raceways 14. Raceways 14 are joined together by means of junction boxes and other junction elements.

The four accelerometric sensors 2a, 2b and the acquisition unit 3 are connected to each other by means of data transmission lines; it is noted that the acquisition unit 3 and the four accelerometric sensors 2a, 2b are connected to each other by means of data transmission lines comprising two CAN bus lines (on which the data is transmitted that is measured by the accelerometric sensors 2a, 2b), a synchronization line (which is a specific line by means of which the instants are indicated at which the accelerometric sensors 2a, 2b must carry out the measurements), and an error signal transmission line (which is a specific line for the transmission of the malfunctioning messages); the acquisition unit 3 is connected to the relative accelerometric sensors 2a, 2b also by means of an electrical line by means of which the acquisition unit 3 power supplies the accelerometric sensors 2a, 2b.

The above lines pass all in the two cables 5.

The acquisition unit 3 is connected to a UPS 6, in turn powered by the mains present inside building 10.

In the case of the seismic monitoring system 1, a generator 12 is also present, located upstream of the UPS 6. In case of power supply failure from the external mains, the UPS 6 first comes into operation; thereafter, after a certain time interval (such as equal to ten minutes), generator 12 automatically comes into operation which for a long time provides for the supply of the electric current required for the functioning of the seismic monitoring system 1.

The acquisition unit 3 is positioned in a point easily accessible also from outside building 10, and, as far as possible, barycentric with respect to the position of the accelerometric sensors 2a, 2b, in order to minimize length of cables 5 (and in particular of the CAN bus lines) connecting the accelerometric sensors 2a, 2b themselves to the acquisition unit 3.

FIG. 11 schematically shows part of the equipment forming part of the seismic monitoring system 1; in particular, the following are shown: an electrical panel 17 of the building, generator 12, an electrical panel 16 upstream of the UPS 6, the UPS 6, an electrical panel 15 downstream of the UPS 6 and the acquisition unit 3. The electrical panel 16, the UPS 6, the electrical panel 15 and the acquisition unit 3 are contained inside a cabinet 29 which is provided with significant resistance properties.

It is noted that the seismic monitoring system 1, once installed at structure 11 and once activated, functions continually, except for the pauses due to maintenance or replacement of components, for the entire useful lifetime of structure 11.

Software is installed in the acquisition unit 3 which allows highlighting, for example by means of an appropriate signal, the malfunction of an accelerometric sensor 2a, 2b, or a power supply failure of the same; this helps to always maintain the perfect efficiency of the seismic monitoring system 1.

The method for carrying out the seismic monitoring of structure 11 using the seismic monitoring system 1 comprises the following steps:
execution, by the accelerometric sensors 2a, 2b, of the acceleration measurements of the points of structure 11 at which the accelerometric sensors 2a, 2b themselves are positioned; each accelerometric sensor 2a, 2b transmits, in real time, the measurements carried out to the acquisition unit 3 with which it is connected; said measurements are carried out, with a predetermined frequency (and thus at predetermined time intervals), at the instants indicated to the accelerometric sensors 2a, 2b by the acquisition unit 3;
acquisition, by the acquisition unit 3, of the data measured by the accelerometric sensors 2a, 2b and storage, by the acquisition unit 3, in its mass memory, which is extractable, of part of the data measured by the accelerometric sensors 2a, 2b themselves; the acquisition unit 3 stores in its mass memory, in addition to said part of the values of the accelerations measured by the accelerometric sensors 2a, 2b connected thereto, also the instants at which they are measured;
retrieve, after a seismic event that affects structure 11, of the data stored by the acquisition unit 3; said retrieve is carried out by turning on the mass memory, which is extractable, of the acquisition unit 3 and extracting said mass memory from the acquisition unit 3 itself;
transfer of said stored (and retrieved) data to an external computer that is not part of said seismic monitoring system 1 and which is situated outside the monitored structure 11; by means of said external computer, starting from the time histories of the accelerations of the points of structure 11 in which the accelerometric sensors 2a, 2b are positioned, the time histories of the displacements of said points of structure 11 are calculated.

It is noted that said data retrieve and said data transfer to said external computer are carried out by manual operations.

With reference to the above method, the following should be noted.

The accelerometric sensors 2a, 2b measure, according to the predetermined frequency indicated by the acquisition unit 3, the accelerations of the points of structure 11 at which they are positioned (these points are significant points of structure 11) and transmit such data in real time to the acquisition unit 3 (to which they are connected).

The acquisition unit 3 acquires the data measured by the accelerometric sensors 2a, 2b and stores in its mass memory part of the data measured by the accelerometric sensors 2a, 2b (connected to the acquisition unit 3). It is noted that the acquisition unit 3 stores in its mass memory only acceleration data identified as “critical”. The acquisition unit 3 then stores, in its mass memory, in addition to the values of the accelerations, also the instants at which these values were measured.

After a seismic event affecting structure 11, the data stored by the acquisition unit 3 is retrieved by accessing the mass memory of the acquisition unit 3. The data retrieve is performed by an operator who extracts the mass storage (the USB key mentioned above) from the acquisition unit 3.

The data stored (and retrieved) is transferred to an external computer. It is noted that the expression “external computer” means a computer that is not “related” to the seismic monitoring system 1 and which, obviously, is placed externally to structure 11, at which the seismic monitoring system 1 is installed.

By means of said external computer, starting from the time histories of the accelerations measured at significant points of structure 11 by the accelerometric sensors 2a, 2b installed there, the time histories of the displacements of said significant points of structure 11 are calculated.

The accelerometric sensors 2a, 2b are positioned in such a number and position as to sufficiently characterize the behavior of building 10 or, better, the behavior of structure 11. Once the seismic monitoring system 1 has been activated, the accelerometric sensors 2a, 2b measure and transmit to the acquisition station 3 the accelerations of the points, belonging to the two pillars 20a and to the relative plinths 24a, at which the accelerometric sensors 2a, 2b themselves are installed; the values of the accelerations are detected continuously, according to a suitable sampling frequency.

The acquisition unit 3, in order to store in its mass memory only part of the data transmitted to it by the accelerometric sensors 2a, 2b connected thereto, executes, substantially in real time, processing of said data.

It should be noted that in order to limit (as much as possible) the use of the mass memory of the acquisition unit 3 and in order to store in the mass memory itself only critical data, a discontinuous storage method is adopted in the case of the seismic monitoring system 1, according to which, as mentioned above and as better described hereinafter, only critical data are stored.

It has been anticipated above that the acquisition unit 3 stores part of the data acquired by the accelerometric sensors 2a, 2b (connected thereto); the method by which the acquisition unit 3 stores this part of data is described hereinafter. It is noted that (in this case), the above method to carry out the seismic monitoring of structure 11 also includes a processing by the acquisition unit 3 of the data transmitted to it by the accelerometric sensors 2a, 2b (which are connected thereto). It is noted that each accelerometric sensor 2a, 2b is of triaxial type and therefore measures three acceleration components according to a predetermined coordinate system of orthogonal Cartesian axes.

The acquisition unit 3 carries out said processing of the data by dividing the data received from the accelerometric sensors 2a, 2b (connected thereto) into data packets and calculating reference parameters, relative to the data contained in each of said data packets in order to identify, following predetermined criteria, whether the values of such parameters are greater than predetermined threshold values; if this happens, and hence if the examined data packet is identified as “critical”, the acquisition unit 3 stores, in its mass memory, said data packet and a predetermined number of data packets which precede the data packet that it is processing, maintained in the RAM memory of the acquisition unit 3.

The acquisition unit 3 continues storing the data transmitted by the four accelerometric sensors 2a, 2b for a sufficiently long time, measured from the instant at which the acquisition unit 3 has identified the last critical data packet.

The reference parameters mentioned above, in the present case, are the effective value or the peak value—the peak of a group of data, as is better specified hereinafter.

The following is some additional information regarding the storage method followed by the acquisition unit 3.

The acquisition unit 3 divides continuously, according to predetermined time intervals (frequency), the data measured by the accelerometric sensors 2a, 2b (such data are related to each of the three acceleration components measured by each of the four accelerometric sensors 2a, 2b) into data packets, all consisting of a same predetermined number of data.

Let t₁ be the instant at which the formation of a generic data packet begins and let t₂ be the instant at which the formation of said data packet terminates, it follows that the time interval in which said data packet is formed is equal to t₂−t₁. Said time interval has same value and remains such over time for all the data packets.

At the instant t₂ᵢ, in which the i-th data packet is completed, the i-th data packet and the last (most recent) N data packets formed immediately before the i-th data packet are present in the RAM memory of the acquisition unit 3, N being a predetermined integer which for example may be comprised between 5 and 30.

Each data packet comprises a set of data groups; each data group is related to one of the three acceleration components measured by one of four accelerometric sensors 2a, 2b.

The number of data groups included in a generic data packet is, therefore, equal to the number of accelerometric sensors 2a, 2b (in this case equal to four) connected to the unit acquisition 3 multiplied by the number of the acceleration components (in this case equal to three) measured by each accelerometric sensor 2a, 2b.

The acquisition unit 3, after having formed the i-th data packet, proceeds with the formation of the subsequent data packet and processes the data of the i-th data packet; in particular, the acquisition unit 3 processes the data of each of said data groups comprised in said i-th data packet, in order to identify whether at least one of said data groups is to be considered critical.

If all the data groups comprised in the i-th data packet result non-“critical”, the acquisition unit 3 does not store, in its mass memory, the data of the i-th data packet. If even only one of the data groups, being part of the i-th data packet, results critical, the acquisition unit 3 stores, in its mass memory, the data contained in the i-th data packet which is identified as “critical data packet”. The acquisition unit 3 also stores, in its mass memory, the N data packets present in the RAM memory thereof that were previously formed; said data packets are those immediately preceding said critical data packet.

The acquisition unit 3 continues to store, in its mass memory, all the data transmitted by the four accelerometric sensors 2a, 2b and continues to form the data packets and to process the data of each data packet, in order to identify (any) critical data packets; the acquisition unit 3 interrupts the storage of the data in its mass memory only after a predetermined time interval has passed (equal to J times the time interval in which each data packet is formed) during which the acquisition unit 3 has detected no critical data packet.

Number J is a predetermined integer (J may be, for example, equal to 50).

It is noted that the acquisition unit 3 continues to store in its mass memory all the data transmitted by the four accelerometric sensors 2a, 2b; the acquisition unit 3 also continues to form the data packets and process the data comprised in each data packet, in order to identify the critical data packets. After identifying the first critical data packet, in case of seismic event, the acquisition unit 3 then identifies other critical data packets; this occurs throughout the seismic event, and thus for a certain time from the instant at which the acquisition unit 3 has identified the first critical data packet. Thereafter, once the seismic action related to the seismic event considered has ended, the acquisition unit 3 continues to store data related to the data packets that it continues to form and process, until a predetermined time interval has passed (established in the design stage of the seismic monitoring system 1), during which the acquisition unit 3 does not identify any critical data packet. This time is counted starting from the final instant of the last time interval in which a data packet has been formed, by the acquisition unit 3, recognized, after its processing, as critical data packet.

It is noted that, at the beginning of a seismic event (in favor of safety), if even one of the accelerometric sensors 2a, 2b measures data such that a group of such data is critical, then the entire data packet, to which the critical data group belongs, is identified as critical and the acquisition unit 3 starts storing data in its mass memory. The parameters and criteria for identifying whether a data packet is critical may be several.

The simplest criterion, and which is also the one adopted by the seismic monitoring systems 1, 30, 60 described in the present description, consists in defining that a data packet is critical if even one of the data groups included therein is critical.

It is clear that, in principle, also other criteria may be followed, such as defining that a data packet is critical if more than one critical data groups thereof are identified.

Moreover, the parameters followed to identify whether a data group (belonging to a generic data packet) is critical or is not critical may be several.

A parameter that can be taken as reference is the effective value of the data group (such effective value is often referred to by the acronym RMS, which stands for “root mean square”).

In this case, in general, each of the one or more acquisition units, during the examination of each data packet, calculates the effective value of each of the data groups included in said data packet; for each data group, the calculated effective value is compared with a predetermined threshold value (RMS threshold value). If the effective value of the data group examined is greater than said threshold value, then such data group is considered critical.

If, therefore, the effective value of the data group examined is greater than a predetermined threshold value (RMS threshold value), the acquisition unit considers such data group as “critical” and consequently (according to the above criterion) identifies the data packet to which said critical data group belongs as “critical”.

Said threshold value was established in the design stage of the seismic monitoring system and was introduced in the acquisition unit considered, at the time of installation of the seismic monitoring system itself.

Another parameter that can be used as a reference for defining whether a package is critical is the peak—peak value of the data group.

In this case, each of the one or more acquisition units, during the examination of each data packet, calculates the peak—peak value of each of the data groups included in said data packet; for each data group, the calculated peak—peak value is compared with a predetermined threshold value (peak—peak threshold value). If the peak—peak value of the data group examined is greater than said threshold value (peak—peak threshold value), then such data group is considered critical.

If, therefore, the peak—peak value of the data group examined is greater than a predetermined threshold value (peak—peak threshold value), the acquisition unit considers such data group as “critical” and consequently (according to the above criterion) identifies the data packet to which said critical data group belongs as “critical”.

If the peak—peak value criterion is adopted, it should be ensured that there are no spikes in the above data packets or they should in some way be detectable as signal “anomalies”. (SEE)

It is clear that in determining the threshold value that identifies the “criticality” of the data group, the background noise of the accelerometric sensors 2a, 2b should be taken into account, so as to suitably deviate from the values related to said background noise.

According to a possible embodiment variant, the threshold values (meaning either the peak—peak value or the RMS threshold value) may be different for each of the accelerometric sensors 2a, 2b.

It is noted that, according to other possible embodiment variants, other criteria may be used to start the storage process. In any case, the storage process is such that from the instant at which the storage process begins up to the instant at which the storage process ends, all the data packets transmitted to the acquisition unit 3 itself by the four accelerometric sensors 2a, 2b are stored in the mass memory of the acquisition unit 3; the N data packets (previously formed) present in the RAM memory at the beginning of the storage process are also stored in said mass memory.

It is noted that the storage system described above, which is based on the identification of critical data packets, does not constitute a seismic recognition system since any dynamic excitation higher than the threshold value of even one of the three acceleration components measured (according to a predetermined reference system) by one of the four accelerometric sensors 2a, 2b activates the data storage (meaning: of the three acceleration components) measured by all four accelerometric sensors 2a, 2b. The data storage can therefore be activated, besides in the event of an earthquake, also due to accidental events (not of seismic nature) that excite only one of the three acceleration components of one of the four accelerometric sensors 2a, 2b. In this case, data are stored in the mass memory of the acquisition unit 3 that is not related to a seismic event; this does not create particular consequences but that part of said mass memory of the acquisition unit 3 is unnecessarily occupied. The seismic monitoring system 1 in which the acquisition unit 3 stores part of the data received from the accelerometric sensors 2a, 2b has been described above. It is noted that this expression is meant to indicate that the acquisition unit 3 only stores data relating to time intervals in which at least one of the accelerometric sensors 2a, 2b has identified acceleration values evaluated as “critical”, meaning that they “are greater” than the usually measured data (and, in particular, greater than the relative predetermined threshold values) and are therefore “potentially significant” for the seismic monitoring of structure 11 (it is noted that data is also stored of the time intervals close to the time intervals in which critical data packets have been detected).

It is noted that, according to the above description, a data packet is considered “critical” if it contains a “critical” data group.

A data group is critical if the data contained therein is not “typical”; such data, in fact, have an anomaly compared to the data that normally forms part of the data groups. This anomaly is the presence of acceleration values greater than those commonly acquired and greater than a predetermined threshold value; this anomaly is detected by following to predetermined criteria and carrying out the appropriate calculation procedures.

It is noted that the definition of “critical data group”, and thus of “critical data packet” simply indicates that it must be stored in the mass memory of the acquisition unit 3 (or, more generally, in the mass memory of the acquisition unit to which the accelerometric sensor is connected). From a seismic point of view, such a data packet, in which an “anomaly” has been found with respect to the typical measurements, may be due to a seismic event but may be due to another cause of dynamic origin such as a shock or the effect of a machine placed inside the building that induces vibrations.

One of the advantages related to storing data only if it is considered critical (or temporally close to critical data), and therefore potentially significant for the seismic monitoring, consists in being able to save mass memory in the acquisition unit 3 so as to have, in the above mass storage, in the generic instant to, data (not deleted) relating to a previous to time interval of considerable duration.

During the operation of the seismic monitoring system 1, when the mass memory of the acquisition unit 3 is substantially full, the data packets related to an event characterized by the presence of at least one critical data packet are stored by the acquisition unit 3 in its mass memory, after deleting the least recent data (the oldest data) present in the mass memory itself.

If a seismic event occurs, the manager of building 10 extracts the mass memory from the acquisition unit 3 and transmits the data to a processing center which can (for example) be managed, or at least coordinated, by the manufacturer of the seismic monitoring system 1; together with the above data, the manager of building 10 also transmits the information necessary for processing the data, such as the parameters that identify the filters (implemented by means of numerical calculation) to be used for the analysis of the signals.

It is noted that the data submitted by the manager of building 10 consists of the time histories of the measured acceleration; it is noted that such data contains the values of the accelerations and the instants at which those values were measured.

Said data processing center, using a computer (which is the external computer mentioned above) executed the dual integration in the time domain of the acceleration values measured during the seismic event, by calculating the values of the displacements of the points of structure 11 at which the accelerometric sensors 2a, 2b are positioned; the time histories of such displacements are thus obtained by means of such processing.

Such time histories of the displacements, along with the time histories of the acceleration measured by the accelerometric sensors 2a, 2b, are very important data for interpreting what the response of structure 11 to said seismic event has been.

It is noted that also the time histories of the accelerations measured by the accelerometric sensors 2b placed at foundation 24 (more precisely, at plinths 24a) are present among the time histories of the accelerations measured; therefore, the accelerometric sensors 2b directly provide the acceleration values due to the seismic event related to foundations 24 themselves.

The manager of building 10 then receives a report from said data processing center containing the results of the displacement calculations and the data, sorted according to a predetermined reading format, of the accelerations measured by the seismic monitoring system 1. The manager of building 10 then transmits said report prepared by the data processing center to the engineer responsible for controlling building 10 after the seismic event; it should be noted that this report includes the time histories of the accelerations and the time histories of the displacements of the points of structure 11 at which the accelerometric sensors 2a, 2b are positioned (significant points of structure 11). The manager of building 10 also transmits to said engineer (in addition to all the project documents of building 10 and of structure 11), also the drawings related to the design of the seismic monitoring system 1 with the location, the name and the orientation of all the accelerometric sensors 2a, 2b, in addition to that of the acquisition unit 3.

It is noted that, immediately after the seismic event, building 10 is evacuated as a precaution; the resumption of activities in building 10 is subject to the verification that said engineer has to carry out on building 10 itself, in particular structure 11.

The engineer, in addition to the data traditionally obtainable by surveys, and thus by the observation of building 10 and in particular by the observation of structure 11, has additional data, which is that provided by the seismic monitoring system 1 (acceleration measurements) and that obtained from said processing of the acceleration measurements. These data obtained by means of the seismic monitoring system 1 usually have a considerable importance: in fact, from these it is possible to obtain (albeit with the inevitable approximations and uncertainties) the values of the accelerations at foundations 24, the values of the accelerations at the covering deck 21, the values of the relative displacements between the base and the top of pillars 20a (and also the values of the relative displacements between the base and the top of pillars 20b) and the values of the drifts of pillars 20a (and also the values of the drifts of pillars 20b) during the seismic event; in particular, both the time histories of these parameters and the maximum values achieved by these parameters during the seismic event can be obtained.

It is noted that structure 11 is such that brittle failure mechanisms are prevented in it and only ductile failure mechanisms are prevented; these failure mechanisms are related to the formation of plastic hinges at the base of pillars 20a, 20b. It is noted that the horizontal reinforced concrete panels 25, placed in the area of building 10 close to the ground level, are bound to the pillars 20a, 20b in such a way as not to (significantly) interfere with the deformations of pillars 20a, 20b themselves. All pillars 20a, 20b can be considered stuck to the base and hinged at the top (it is noted that the position of the top hinge takes two values: one relating to the static longitudinal frame scheme and the other relating to the static transverse frame scheme). It has been described above that the covering deck 21 is such as to be considered rigid in its plane; moreover, foundations 24 (considered as a whole) may also be considered rigid in their plane so that the engineer, taking into consideration these conditions, can calculate the drifts of all pillars 20a, 20b (and 20c, as well) of structure 11 and not only the drifts of the directly monitored pillars 20a.

The engineer, therefore, in order to carry out the verification of building 10, and in particular of structure 11, in addition to the results obtained by the visual observation of the effects of seismic actions on structure 11, also has data available concerning the actual seismic response of structure 11 (in fact, the accelerations and the displacements of said significant points of structure 11 are known) measured during the seismic event. The engineer therefore has direct measurements carried out by the seismic monitoring system 1 on structure 11, at the time of the seismic event. The engineer also has results obtained by processing such measurements.

After the examination of all results in his possession, the engineer decides whether it is possible to immediately resume the activities inside building 10 or if it is necessary to carry out restoration or retrieve works relating to structure 11 or building 10.

It is clear that in order for the results provided by the seismic monitoring system 1 to be (particularly) useful, the accelerometric sensors 2a and 2b must be placed at points “representative” of the behavior of structure 11, i.e. at points where the knowledge of the accelerations, or rather of the displacements, is particularly important for the determination of the dynamic response of structure 11 to the seismic event.

It is noted, in general, that the choice of the number and positioning of the accelerometric sensors, when designing the seismic monitoring system, must be made by a structural engineer after studying carefully the structure to be monitored and, in particular, after identifying all local and global failure mechanisms and having prevented, with suitable dimensioning and construction details, possible brittle failure mechanisms.

It is noted (in general) that the study of the building, and in particular of the structure of the building itself, is required to properly design the seismic monitoring system to be used. In the case of a new construction, the information regarding the structure to be monitored is available at the design engineer of the structure; such a design engineer knows the structure to the best and therefore knows how to identify the significant points thereof for determining the response of the structure to a seismic event. Moreover, in some cases, it may be assumed that the design engineer of a structure is also the one who then, once a seismic event has occurred that has affected the above structure, is responsible for verifying the situation of the structure after the earthquake (or rather the building of which it forms part).

The seismic monitoring system therefore appears as consisting of a set of “instruments” of the design engineer positioned at points of the structure indicated by the engineer himself, for which he wants to know, in case of a seismic event, the values of accelerations and displacements.

Referring to FIGS. 12, 13, 14, 15, 16, 17, 18, 19, 20 and 21, the seismic monitoring system 30 obtained according to the present invention is described, according to another embodiment thereof. The seismic monitoring system 30 is installed at a reinforced concrete structure 41 of a building 40 for commercial use. Building 40 is a new construction; structure 41 comprises structural reinforced concrete and prestressed reinforced concrete elements and is such that brittle failure mechanisms are prevented therein and only ductile failure mechanisms are possible. Structure 41 includes prefabricated reinforced concrete pillars 50a, 50b, a covering deck 51 and foundations 54 made of reinforced concrete cast on site. The covering deck 51 includes prefabricated prestressed reinforced concrete beams 51a, 51b and prefabricated prestressed reinforced concrete roof tiles 51c.

Building 40 is located in a seismic zone. The plane of building 40 has a courtyard of significant size; moreover, the covering deck 51 has also skylights, not shown in the figures, whose presence contributes to making the covering deck 51 itself “deformable” in its plane. From the above description it follows that the covering deck 51 of structure 41, although formed by prefabricated elements connected to each other, cannot be considered to be (completely) rigid in its plane (contrary to what happens, for example, in the case of structure 11 which, instead, can be regarded as having a “rigid” deck).

Foundations 54 comprise “cup” plinths 54a, 54b and connecting beams 54c which substantially prevent the relative displacements, in the horizontal plane, between the above plinths 54a, 54b. A reinforced concrete slab is also present which constitutes the industrial flooring of building 40.

Foundations 54 extend over an area similar to that of the covering deck 51; foundations 54 therefore have a substantial extension; also, the ground on which foundations 54 rest is (basically) inhomogeneous.

It is noted that the structural elements that form structure 41 are mutually connected according to the resistance hierarchy criteria; the above-mentioned structural elements and the connections between the structural elements are made with such criteria and construction details that brittle failures are prevented, thus ductile failure mechanisms only being possible.

The curtain wall, on the four sides of building 40, comprises horizontal reinforced concrete panels 55, which constitute a first band of the curtain wall, and sandwich panels 56, consisting of two metal sheets and interposed insulating layer, placed above said first band; the sandwich panels 56 are provided with appropriate metal structures not shown, for simplicity, in the figures.

The seismic monitoring system 30 includes:
sixteen accelerometric sensors 32a, 32b positioned at significant points of structure 41; the eight accelerometric sensors 32a are positioned at the intrados of the covering deck 51; the eight accelerometric sensors 32b are positioned at foundations 54; it should be noted that the eight accelerometric sensors 32a are positioned at pillars 50a; the eight accelerometric sensors 32b are positioned at the extrados of plinths 54a, in the vicinity of pillars 50a and within as many pits 58 (technically equivalent to pits 28) placed adjacent pillars 50a;
two acquisition units 33a, 33b to which the accelerometric sensors 32a, 32b are connected; the two acquisition units 33a, 33b continuously receive data from the accelerometric sensors 32a, 32b to which they are connected; one of the two acquisition units (the acquisition unit 33a) is the master acquisition unit while the other acquisition unit (the acquisition unit 33b) is the slave acquisition unit.

The seismic monitoring system 30, once installed at structure 41 and once activated, functions continually, except for the pauses due to maintenance or replacement of components, for the entire useful lifetime of structure 41.

The accelerometric sensors 32a, 32b are technically equivalent to the accelerometric sensors 2a, 2b.

The accelerometric sensors 32a, 32b measure, with a predetermined frequency, the values of the accelerations of the points at which the accelerometric sensors 32a, 32b themselves are positioned. The (master) acquisition unit 33a synchronizes the measurements of all the sixteen accelerometric sensors 32a, 32b comprised in the seismic monitoring system 30, indicating to all the sixteen accelerometric sensors 32a, 32b the instants at which they must carry out the measurements (of acceleration).

Each of the two acquisition units 33a, 33b comprises, in addition to a RAM memory, a mass memory in which part of the data measured by the accelerometric sensors 33a, 32b connected to the acquisition unit 33a, 33b considered and transmitted by said accelerometric sensors 32a, 32b to the acquisition unit 33a, 33b itself is stored; in said mass memory, the instants are also stored at which such data has been measured; said mass memory is extractable and consists of a USB key provided with adequate memory capacity.

Each of the two acquisition units 33a, 33b preserves, in its mass memory, only the most recent data, canceling the less recent data before introducing new data; in this way, each of the two the acquisition units 33a, 33b maintains its mass memory updated.

Each of the two acquisition units 33a, 33b also provides the necessary electrical energy to the accelerometric sensors 32a, 32b which are connected to it.

The seismic monitoring system 30, if structure 41 is subjected to seismic actions, is adapted to be used so to be able to identify, in addition to the accelerations, also the displacements of the points of structure 41 at which the accelerometric sensors 32a, 32b are positioned; said displacements are obtained by means of processing, executed after the seismic event, of the acceleration measurements carried out by the accelerometric sensors 32a, 32b; such processing is carried out by means of an external computer that is not part of the seismic monitoring system 30 and which is situated outside the monitored structure 41.

It is noted that the above displacements are calculated by executing a dual integration in the time domain of the time histories of the accelerations measured.

The (slave) acquisition unit 33b and the (master) acquisition unit 33a are connected to the corresponding accelerometric sensors 32a, 32b; the (slave) acquisition unit 33b (slave) is connected to the (master) acquisition unit 33a.

It should be noted that the (master) acquisition unit 33a synchronizes the measurements of all the accelerometric sensors 32a, 32b indicating, to the accelerometric sensors 32a, 32b themselves, the instants at which they must carry out the measurements of acceleration; this synchronization is implemented using signals sent, through a specific transmission line (which is the first synchronization line), by the master acquisition unit 33a to all the sixteen accelerometric sensors 32a, 32b. In this way, the sixteen accelerometric sensors 32a, 32b carry out the acceleration measurements “simultaneously”, at predetermined instants.

Each of the two acquisition units 33a, 33b, which is technically equivalent to the acquisition unit 3, comprises a microprocessor, a user communication system (comprising a touch screen and the components required for the functioning of the touch screen itself), a RAM memory, a mass memory in which part of the data transmitted by the accelerometric sensors 32a, 32b is stored, a clock generator, a USB bus driver for the management of the mass memory, a circuit for the input of the error messages from the accelerometric sensors 32a, 32b, connectors for connection with two CAN bus lines and with other data transmission lines, connectors for the connection with the other acquisition unit 33a, 33b, a transformer and a power supply unit; said mass memory is extractable.

It is noted that the acquisition unit 33a includes the clock generator which is used by the entire the seismic monitoring system 30 and, in particular, by all sixteen accelerometric sensors 32a, 32b. The clock generator “physically” present in the acquisition unit 33b is bypassed, so as to allow an “exact” synchronism of all the accelerometric sensors 32a, 32b connected to the two acquisition units 33a, 33b.

With reference to the number (and position) of the accelerometric sensors 32a, 32b, the following is noted. Taking into consideration the deformability of the covering deck 51 in its plane as well as the extension of foundations 54, and the fact that they are located on a (substantially) non-homogeneous ground, it is deduced that, in order to be able to identify the displacements of the top and the base of each pillar 50b with sufficient accuracy, the deformation of the covering deck 51 and of foundations 54 must be suitably known. In order to achieve this objective, since it is no longer possible to rely on the (substantial) hypothesis of non-deformability in its plane of both the covering deck 21 and foundations 24, for structure 41 it is necessary to adopt a greater number of accelerometric sensors than that used in the case of structure 11. Also in the case of building 40, redundancy criteria are also adopted in determining the number of accelerometric sensors 32a, 32b in order to ensure, even if during the seismic event one or more accelerometric sensors 32a, 32b stops functioning, a data collection that is sufficient and effective for identifying the seismic response of structure 41. It is noted that the seismic monitoring system 30 uses, at foundations 54, a number of accelerometric sensors 32b equal to the number of accelerometric sensors 32a present at the covering deck 51.

Eight accelerometric sensors 32a, 32b and the acquisition unit 33a are connected to one another via cable.

It is noted that four cables 35 are present; each cable 35 is connected to two accelerometric sensors 32b, two accelerometric sensors 32a and to one of the two acquisition units 33a, 33b. The four cables 35 are inserted into cable raceways 44. Raceways 44 are joined together by means of junction boxes and other junction elements.

Each of the two acquisition units 33a, 33b and the relative eight accelerometric sensors 32a, 32b are connected to each other by means of data transmission lines; it is noted that these data transmission lines comprise two CAN bus lines (on which the data is transmitted that is measured by the accelerometric sensors 32a, 32b), a synchronization line (which is a specific line by means of which the instants are indicated at which the accelerometric sensors 32a, 32b must carry out the measurements), and an error signal transmission line (which is a specific line for the transmission of the malfunctioning messages); each of the two acquisition units 33a, 33b is connected to the relative eight accelerometric sensors 32a, 32b also by means of an electrical line by means of which the acquisition unit 33a, 33b power supplies the accelerometric sensors 32a, 32b. It is noted that each acquisition unit 33a, 33b and the relative accelerometric sensors 32a, 32b are connected to one another by means of a CAN bus network comprising two CAN bus lines. An accelerometric sensor 32a and two accelerometric sensors 32b are connected on each of the above two CAN bus lines, one after the other; each of the two CAN bus lines is then connected to said acquisition unit 33a, 33b.

The above lines pass all in cables 35. In particular, it is noted that each of the two acquisition units 33a, 33b is connected to four of the relative eight accelerometric sensors 32a, 32b by means of a CAN bus line and is connected to the remaining four accelerometric sensors 32a, 32b by means of another CAN bus line; therefore, each of the two acquisition units 33a, 33b is connected to the relative eight accelerometric sensors 32a, 32b by means of two CAN lines.

Each of the two acquisition units 33a, 33b is connected to its own UPS 6, not shown in the figures, which is powered by the mains present inside building 40.

The two acquisition units 33a, 33b are placed outside building 40. Each of the two acquisition units 33a, 33b is placed inside a concrete container 59 provided with a door to access the acquisition unit 33a, 33b placed therein.

Cables 35 are technically equivalent to cables 5.

The two acquisition units 33a, 33b are connected to each other by means of a cable 36.

The two acquisition units 33a, 33b are connected to each other by means of data transmission lines also comprising a first synchronization line which is used for synchronizing all the accelerometric sensors 32a, 32b, a second synchronization line which is used for synchronizing the instants at which the two acquisition units 33a, 33b begin to form data packets (read hereinafter) and a line for signaling the critical data packets.

It is noted, in general, that if the seismic monitoring system includes more than two acquisition units, they must be connected one after the other according to a closed scheme that allows, among other things, the real-time communication between all the acquisition units of the successful identification of at least one “critical” data packet.

The accelerometric sensors 32a, 32b, as described above, measured at predetermined instants, according to the predetermined frequency (time intervals) indicated by the (master) acquisition unit 33a, the accelerations of the points of structure 41 at which the accelerometric sensors 32a, 32b are positioned; each accelerometric sensor 32a, 32b then transmits the data measured to the acquisition unit 33a, 33b to which it is connected. Each of the two acquisition units 33a, 33b, in order to store in its mass memory only part of the data transmitted to it by the accelerometric sensors 32a, 32b connected thereto, executes, substantially in real time, processing of said data.

It is specified that the two acquisition units 33a, 33b store part of the data acquired by the accelerometric sensors 32a, 32b connected thereto using a data storage strategy in their mass memory which is technically equivalent to the strategy already described with reference to the acquisition unit 3.

Each of the two acquisition units 33a, 33b carries out said processing of the data by dividing the data received from the accelerometric sensors 32a, 32b connected thereto into data packets (the forming of which is synchronized by the master acquisition unit 33a) and calculating reference parameters, relative to the data contained in each of said data packets in order to identify, following predetermined criteria, whether the values of such parameters are greater than predetermined threshold values; if this happens, and hence if the examined data packet is identified as “critical”, the acquisition unit 33a, 33b considered stores, in its mass memory, said data packet and a predetermined number of data packets which precede the data packet that it is processing, maintained in the RAM memory of said acquisition unit 33a, 33b. Furthermore, said acquisition unit 33a, 33b communicates, in real time, the presence of said critical data packet to the other acquisition unit 33a, 33b; such other acquisition unit 33a, 33b then stores in its mass memory the data packets present in its RAM memory.

Each of the two acquisition units 33a, 33b continues storing the data transmitted by all the eight accelerometric sensors 32a, 32b connected thereto for a sufficiently long time, measured starting from the instant at which a critical data packet has been identified by any of the two acquisition units 33a, 33b.

The reference parameters mentioned above, in the present case, are the effective value or the peak value—the peak of a group of data, as is better specified hereinafter.

The following is some additional information regarding the storage method followed by the two acquisition units 33a, 33b.

Each of the two acquisition units 33a, 33b continuously divides, according to a predetermined frequency, the data measured by the accelerometric sensors 32a, 32b connected thereto into data packets, all composed of a same predetermined number of data.

Let t₁ be the instant at which the formation of a generic data packet begins and let t₂ be the instant at which the formation of said data packet terminates, it follows that the time interval in which said data packet is formed is equal to t₂−t₁. Said time interval has same value and remains such over time for all the data packets and for each of the two acquisition units 33a, 33b.

The two acquisition units 33a, 33b are synchronized with each other. The clock generator function is carried out by the master acquisition unit 33a; the master acquisition unit 33a indicates to itself and to the slave acquisition unit 33b the initial instants for the formation of data packets.

It is noted that the generic i-th data packet that is formed by the acquisition unit 33a is formed at the same time as the i-th data packet that is formed by the acquisition unit 33b.

At the instant t₂ᵢ, in which the i-th data packet is completed, the i-th data packet and the last (most recent) N data packets formed immediately before the i-th data packet are present in the RAM memory of each of the two acquisition units 33a, 33b; N is a predetermined integer which for example may be comprised between 5 and 30.

In each of the two acquisition units 33a, 33b, each data packet comprises a set of data groups; each data group relates to one of the three components of the acceleration measured by one of the eight accelerometric sensors 32a, 32b connected to the considered acquisition unit 33a, 33b; the number of data groups comprised in a generic data packet is therefore equal to the number of the accelerometric sensors 32a, 32b connected to the considered acquisition unit 33a, 33b (such a number is eight) multiplied by the number of the components of the acceleration (such a number is three) measured by each of said accelerometric sensors 32a, 32b.

Each of the two acquisition units 33a, 33b, after having formed a data packet (the i-th data packet), proceeds with the formation of the subsequent data packet and at the same time processes the data of the i-th data packet; in particular, it processes the data of each of said data groups comprised in said i-th data packet, in order to identify whether at least one of said data groups is to be considered critical.

Let's consider now, for example, the acquisition unit 33b (identical remarks apply if the acquisition unit 33a is taken as example).

The acquisition unit 33b, therefore, after having formed a data packet (the i-th data packet), while proceeding with the formation of the subsequent data packet it processes the data of the i-th data packet; in particular, it processes the data of each of said data groups in order to identify whether at least one of said data groups is to be considered critical.

If all the data groups comprised in the i-th data packet result non-“critical”, said acquisition unit 33b does not store, in its mass memory, the data of the i-th data packet.

If even only one of the data groups, being part of the (examined) i-th data packet, results critical, the acquisition unit 33b stores, in its mass memory, the data contained in the i-th data packet which is identified as “critical data packet”.

The acquisition unit 33b also stores, in its mass memory, the N data packets present in the RAM memory thereof that were previously formed (these are the N data packets immediately preceding said critical data packet).

In addition, said acquisition unit 33b communicates, in real time, the presence of said critical data packet to the acquisition unit 33a.

The acquisition unit 33a, as the acquisition unit 33b did, stores in its mass memory the i-th data packet formed by the acquisition unit 33a itself (this data packet is concurrent to the above i-th critical data packet) and stores in its mass memory also the previously formed data packets present in its RAM memory (these are the N data packets immediately preceding said i-th data packet).

For the communications between the acquisition unit 33a and the acquisition unit 33b regarding the presence of critical data packets, the specific data transmission line (mentioned above) is used.

Each of the two acquisition units 33a, 33b continues to store, in its mass memory, all the data transmitted by the eight accelerometric sensors 32a, 2b connected thereto and continues to form the data packets and to process the data of each data packet, in order to identify the critical data packets; each of the two acquisition units 33a, 33b interrupts the storage of the data in its mass memory only after a predetermined time interval has passed (equal to J times the time interval in which each data packet is formed) during which none of the two acquisition units 33a, 33b has detected any critical data packet; J is a predetermined integer.

After the first critical data packet has been identified, in case of seismic event, each of the two acquisition units 33a, 33b then identifies other critical data packets; this occurs throughout the seismic event, and thus for a certain time from the instant at which at least one of the two acquisition units 33a, 33b has identified the first critical data packet. Thereafter, once the seismic action related to the seismic event considered has ended, the two acquisition units 33a, 33b continue to store data related to the data packets that they continue to form and process, until a predetermined time interval has passed (established in the design stage of the seismic monitoring system 30), during which none of the two acquisition units 33a, 33b identifies any critical data packet. This time is counted starting from the final instant of the last time interval in which a data packet has been formed, or by the acquisition unit 33a or by the acquisition unit 33b, recognized, after its processing, as critical data packet.

It is noted that, at the beginning of a seismic event (in favor of safety), if even one of the accelerometric sensors 33a, 32b connected to one of the acquisition units 33a, 33b measures data such that a group of such data is critical, then the entire data packet, to which the critical data group belongs, is identified as critical and each of the two acquisition units 33a, 33b starts storing data in its mass memory.

The data transmission lines (for data transmission between the two acquisition units 33a, 33b), the first synchronization line (through which the (master) acquisition unit 33a synchronizes all sixteen accelerometric sensors 32a, 32b with regard to the acceleration measurements), the second synchronization line (through which the (master) acquisition unit 33a synchronizes the acquisition unit 33b, as regards the initial instants of formation of data packets), and the line for communications regarding critical data packets all pass into cable 36, which connects the two acquisition units 33a, 33b.

According to other possible embodiment variants, other criteria may be used, even less restrictive than the criterion described above, so that the two acquisition units 33a, 33b begin to store in their mass memory the data contained in the data packets (according to the above description); one such alternative criteria may in fact provide that at least two data packets, both related to a same time interval, measured by two accelerometric sensors 32a, 32b, should be recognized as critical for the two acquisition units 33a, 33b to begin the above process of storing the data packets in their mass memory. In any case, from the instant at which the two acquisition units 33a, 33b begin the storage process up to the instant at which the two acquisition units 33a, 33b end this process, in addition to all the data packets residing at the initial instant of this storage process in the RAM memory of each of the two acquisition units 33a, 33b, also the data packets relating to the three components of the acceleration (measured according to the predetermined reference system) of all sixteen accelerometric sensors 32a, 32b are also stored.

According to a further possible embodiment variant, the seismic monitoring system 30 may also include an alarm indicator that is activated, inside building 40, when a data packet related to one of the sixteen accelerometric sensors 32a, 32b is detected as a critic. It should be noted that, according to the above description, said alarm indicator is inevitably also activated in the presence of dynamic events, not of seismic nature, which make one or more data packets of even only one of the sixteen accelerometric sensors 32a, 32b critical.

According to the embodiment shown, each of the two acquisition units 33a, 33b stores the “significant” data, that is, corresponding to the identification of one or more critical data packets, only in its mass memory.

It is noted that the (master) acquisition unit 33a has a clock generator function for all sixteen accelerometric sensors 32a, 32b and also has a clock generator function for both the acquisition unit 33a, 33b (and, in general, for all the acquisition units present in a generic seismic monitoring system implemented according to the present invention) as regards the formation and processing of the data packets. Therefore, the time intervals in which the two acquisition units 33a, 33b form the data packets transmitted by the respective accelerometric sensors 32a, 32b, or rather the initial instants which identify these intervals are synchronized by the (master) acquisition unit 33a that sends a specific signal to the (slave) acquisition unit 33b; such signal synchronizes, for the two acquisition units 33a, 33b, the formation of data packets received from the corresponding accelerometric sensors 32a, 32b, making the start of the formation of such data packets simultaneous and therefore, ultimately, making the time intervals related to the formation of the data packets themselves equivalent and synchronized, for the two acquisition units 33a, 33b. It is noted that in this way, the two acquisition units 33a, 33b operate “simultaneously”; this is essential to be able to compare and correlate the collected data.

It is noted that the (slave) acquisition unit 33b, as regards the hardware, is equivalent to the (master) acquisition unit 33a. The acquisition 33a differs from the acquisition unit 33b in that the clock generator function of the acquisition unit 33b is bypassed by the clock generator of the acquisition unit 33a which synchronizes all the accelerometric sensors 32a, 32b, and in that the clock generator function for the formation and processing of the data packets is carried out by the acquisition unit 33a.

According to a further possible embodiment variant, once the storage has ended, as described above, after the identification of at least one critical data packet, the slave acquisition unit transmits, not in real time, such stored data to the master acquisition unit using the data transmission line that connects the two acquisition units. The slave acquisition unit transmits to the master acquisition unit, in addition to the above data, also the instants at which they were measured by the accelerometric sensors connected to the acquisition unit itself. Therefore, according to such embodiment variant, the slave acquisition unit transmits the data already stored in its mass memory to the master acquisition unit, which stores it in its mass memory, in addition to the data already stored in the mass memory itself, measured by the accelerometric sensors directly connected to the master acquisition unit.

The acquisition unit 33a has a mass memory such that, both the data stored by the acquisition unit 33a itself and by the acquisition unit 33b are stored in such a mass memory. Such embodiment variant allows the operator, who after the seismic event extracts the data measured by the accelerometric sensors 32a, 32b, to extract them from a single mass memory (such as that of the acquisition unit 33a) instead of from the mass memory of each of the two acquisition units 33a, 33b.

The seismic monitoring system 30 in which the two acquisition units 33a, 33b store part of the data received from the accelerometric sensors 32a, 32b has been described above. It is noted that this expression means that the two acquisition units 33a, 33b only store the data relating to time intervals in which at least one of the accelerometric sensors 32a, 32b has identified acceleration values to be considered as significant. Within each of said time intervals, each of the two acquisition units 33a, 33b stores all the data (such data relate to the three components of the acceleration directed according to a predetermined coordinate system of orthogonal Cartesian axes coming from all the accelerometric sensors 32a, 32b connected thereto, sampled with the frequency expected for the seismic monitoring system 30. The method for carrying out the seismic monitoring (of structure 41) using the seismic monitoring system 30 comprises operations technically equivalent to the operations relating to the method for carrying out the seismic monitoring (of structure 11) using the seismic monitoring system 1 described above. It is noted that the above method comprises the following operations:
execution, by the accelerometric sensors 32a, 32b, of the acceleration measurements of the points of structure 41 at which the accelerometric sensors 32a, 32b themselves are positioned; each accelerometric sensor 32a, 32b transmits, in real time, the measurements carried out to the acquisition unit 33a, 33b with which it is connected; said measurements are carried out, with a predetermined frequency, at the instants indicated to the accelerometric sensors 32a, 32b by the (master) acquisition unit 33a (comprised in the seismic monitoring system 30);
acquisition, by each of the two acquisition units 33a, 33b, of the data measured by the accelerometric sensors 32a, 32b connected thereto and storage, by each of the two acquisition units 33a, 33b, in their mass memory, which is extractable, of part of the data measured by the accelerometric sensors 32a, 32b connected to said acquisition unit 33a, 33b; each of the two acquisition units 33a, 33b stores in its mass memory, in addition to said part of the values of the accelerations measured by the accelerometric sensors 32a, 32b connected thereto, also the instants at which they are measured;
retrieve, after a seismic event that affects structure 41, of the data stored by the two acquisition units 33a, 33b; said retrieve is carried out by turning on the mass memory, which is extractable, of each of the two acquisition units 33a, 33b and extracting the mass memory itself from each of the two acquisition units 33a, 33b;
transfer of said stored (and retrieved) data to an external computer that is not part of the seismic monitoring system 30 and which is situated outside the monitored structure 41; by means of said external computer, starting from the time histories of the accelerations of the points (which are significant points) of structure 41 in which the accelerometric sensors 32a, 32b are positioned, the time histories of the displacements of said points of structure 41 are calculated.

It is noted that said data y and said data transfer to said external computer are carried out by manual operations.

With reference to the method for carrying out the seismic monitoring (of structure 41) using the seismic monitoring system 30, it is noted that, assuming that a seismic event has occurred which affected building 40, the following takes place.

The manager of building 40, instead of sending the data obtained from the seismic monitoring system 30 to a data processing center to be able to provide the engineer (in charge of verifying the condition of building 40 after the seismic event) with the results of the processing of such data, sends this data directly to said engineer. Such engineer, therefore, making use of his own computer and of a calculation procedure (which can be supported by a commercial calculation program), carries out the processing necessary to identify the time histories of the displacements of significant points of structure 41 (at which the accelerometric sensors 32a, 32b are positioned) from the time histories of the accelerations, directly “read” from the data stored in the mass memories of the two acquisition units 33a, 33b. Said engineer, therefore, in this case, processes the data which, together with other information resulting from the inspections carried out by the engineer himself to examine building 40 and in particular structure 41, provide him with very useful elements for carrying out the necessary structural verifications and making decisions regarding building 40 itself. It is noted that, in this case, the external computer mentioned above is said computer of said engineer.

Referring to FIGS. 22, 23, 24, 25, 26, 27 and 28, the seismic monitoring system 60 obtained according to the present invention is described, according to a further embodiment thereof. The seismic monitoring system 60 is installed at a structure 71 of a residential building 40 made of reinforced concrete cast on site. Structure 71 of building 70 comprises three horizontal elements 81, 82, 83, pillars 80a, 80b, baffles 85 forming the stairwell, and foundation 84.

Building 70 is located in a seismic zone, therefore it is designed and built according to the criteria of structures located in seismic areas; in particular, ductile failure mechanisms are only possible in such building 70 (therefore, brittle failure mechanisms are not deemed possible).

In the figures, for simplicity of representation, the external curtain walls and the internal partitions of building 70 are not shown.

The seismic monitoring system 60 includes:
sixteen mono-axial accelerometric sensors 62a, 62b, 62c, 62d positioned at significant points of structure 71; the four accelerometric sensors 62a are positioned at the intrados of the third horizontal element 81 (which constitutes the covering horizontal element); the four accelerometric sensors 62b are positioned at the intrados of the second horizontal element 82; the four accelerometric sensors 62c are positioned at the first horizontal element 83; the four accelerometric sensors 62d are positioned at foundation 84. Six accelerometric sensors 62a, 62b, 62c are positioned at pillar 80a; the other six accelerometric sensors 62a, 62b, 62c are positioned at pillar 80b; the four accelerometric sensors 62d are positioned at foundation 84, in the vicinity of the two pillars 80a, 80b; it should be noted that the four accelerometric sensors 62d are positioned at four pits 88, each of which is technically equivalent to one of pits 28;
two acquisition units 63a, 63b to which the accelerometric sensors 62a, 62b, 62c, 62d are connected; each of the two acquisition units 63a, 63b continuously receives data from the accelerometric sensors 62a, 62b, 62c, 62d to which they are connected; one of the two acquisition units (the acquisition unit 63a) is the master acquisition unit while the other acquisition unit (the acquisition unit 63b) is the slave acquisition unit.

The seismic monitoring system 60, once installed at structure 71 and once activated, functions continually, except for the pauses due to maintenance or replacement of components, for the entire useful lifetime of structure 71.

The accelerometric sensors 62a, 62b, 62c, 62d measure, with a predetermined frequency, the values of the accelerations of the points at which the accelerometric sensors 62a, 62b, 62c, 62d themselves are positioned.

The (master) acquisition unit 63a synchronizes the measurements of all the sixteen accelerometric sensors 62a, 62b, 62c, 62d comprised in the seismic monitoring system 60, indicating to all the sixteen accelerometric sensors 62a, 62b, 62c, 62d the instants at which they must carry out the measurements (of acceleration).

Each of the two acquisition units 63a, 63b comprises, in addition to a RAM memory, a mass memory in which the data measured by the accelerometric sensors 63a62a, 62b, 62c, 62d connected to the acquisition unit 63a, 63b considered and transmitted by said accelerometric sensors 62a, 62b, 62c, 62d to the acquisition unit 63a, 63b itself is stored; in said mass memory, the instants are also stored at which such data has been measured; said mass memory is extractable. Such mass memory consists of a USB key provided with adequate memory capacity.

It is noted that each of the two acquisition units 63a, 63b stores, in the extractable mass memory thereof, all the data measured by the accelerometric sensors 62a, 62b, 62c, 62d connected thereto.

Each of the two acquisition units 63a, 63b preserves, in its mass memory, only the most recent data, canceling the less recent data before introducing new data; in this way, each of the two the acquisition units 63a, 63b maintains its mass memory updated.

Each of the two acquisition units 63a, 63b also provides the necessary electrical energy to the accelerometric sensors 62a, 62b, 62c, 62d which are connected to it. The seismic monitoring system 60, if structure 71 is subjected to seismic actions, is adapted to be used so to be able to identify, after the seismic event, in addition to the accelerations, also the displacements of the points of structure 71 at which the accelerometric sensors 62a, 62b, 62c, 62d are positioned; said displacements are obtained by means of processing, executed after the seismic event, of the acceleration measurements carried out by the accelerometric sensors 62a, 62b, 62c, 62d; such processing is carried out by means of an external computer that is not part of the seismic monitoring system 60 and which is situated outside the monitored structure 71.

The (slave) acquisition unit 63b and the (master) acquisition unit 63a are connected to the corresponding accelerometric sensors 62a, 62b, 62c, 62d; the (slave) acquisition unit 63b (slave) is connected to the (master) acquisition unit 63a.

It is noted that the (master) acquisition unit 63a synchronizes the measurements of all the accelerometric sensors 62a, 62b, 62c, 62d, indicating to the accelerometric sensors 62a, 62b, 62c, 62d themselves the instants at which they must carry out the measurements of acceleration.

The accelerometric sensors 62a, 62b, 62c, 62d are connected to the two acquisition units 63a, 63b by means of cables 65; these cables 65 are inserted into cable raceways 74; raceways 74 are joined to each other at junction boxes 75. It is noted that eight of the sixteen accelerometric sensors 62a, 62b, 62c, 62d are connected to the acquisition unit 63a and that the remaining eight accelerometric sensors 62a, 62b, 62c, 62d are connected to the acquisition unit 63b.

It is noted that the accelerometric sensors 62a, 62b, 62c, 80a are integral with the respective two pillars.

The pattern of cables 65 (and thus the pattern of the cable raceways 74 inside which cables 65 are positioned) is mostly vertical, along the respective pillars 80a.

The accelerometric sensors 62a, 62b, 62c, 62d are of capacitive type and are of mono-axial type; the output signal is of analog type. It is noted that each of the accelerometric sensors 62a, 62b, 62c, 62d is, more precisely, simply an accelerometer inserted inside a containment element which protects the accelerometer itself and which allows the fixing thereof to structure 71. It is noted that the accelerometric sensors 62a, 62b, 62c, 62d do not include, for example, microprocessors, temperature sensors, etc.

The accelerometric sensors 62a, 62b, 62c, 62d are connected to the respective acquisition unit 63a, 63b by a star layout; therefore, each accelerometric sensor 62a, 62b, 62c, 62d is connected directly, with its own cable 65 (comprising multiple conductors), to the respective acquisition unit 63a, 63b. This entails, with respect to the (substantially) serial connection used in the case of the seismic monitoring systems 1 and 30, the use of a larger number of cables, which also implies more expensive installation operations and the need to use larger cable raceways 74.

The two acquisition units 63a, 63b have performance and capacity technically equivalent to those of the two acquisition units 33a, 33b; moreover, the two acquisition units 63a, 63b convert the analog signals transmitted to them by the respective accelerometric sensors 62a, 62b, 62c, 62d into digital data. It is noted that, in the subject case, considering the size of the monitored structure 71, cables 65 that connect the accelerometric sensors 62a, 62b, 62c, 62d to the respective acquisition units 63a, 63b have a limited length and hence such as not to give rise to particularly high background noise.

The two acquisition units 63a, 63b are placed outside building 70. Each of the two acquisition units 63a, 63b is placed inside a concrete container 89 provided with a door to access the acquisition unit 63a, 63b placed therein.

Each of the two acquisition units 63a, 63b is equivalent as regards the hardware; for example, the acquisition unit 63a is described hereinafter; the same remarks apply to the acquisition unit 63b.

The acquisition unit 63a includes a RAM and a mass memory that is extractable.

The acquisition unit 63a includes one or more microprocessors, a user communication system, a data writing unit, a storage unit, a RAM memory, an extractable mass memory in which the data transmitted by the accelerometric sensors 62a, 62b, 62c, 62d is stored, a clock generator, components for control, error reporting, and communication functions with the acquisition unit 63b, a transformer and a power supply unit. Said mass memory is extractable.

The mass memory consists of a hard disk having suitable characteristics. Such hard drive is extractable.

Both the data writing unit and the storage unit communicate “simultaneously” with the RAM. The data writing unit receives the analog signals from the accelerometric sensors 62a, 62b, 62c, 62d, connected to the acquisition unit 63a, converts them into digital data and stores them in the RAM memory. Such data, once stored in the RAM, is read by the storage unit which transfers it, according to a predetermined ordered sequence, to the extractable mass memory. A procedure regulates said operations which must be carried out in the manner and within the time set in the design stage of the acquisition unit 63a.

It is noted that the acquisition unit 63a synchronizes all sixteen accelerometric sensors 62a, 62b, 62c, 62d as regards the acceleration measurements.

The method for carrying out the seismic monitoring of structure 71 using the seismic monitoring system 60 is technically equivalent to the operations relating to the method for carrying out the seismic monitoring of structure 41 using the seismic monitoring system 30 described above.

As regards data processing carried out by an external computer after structure 71 has undergone a seismic event, it is noted that such data processing substantially consists in the calculation of the displacements of said points (which are significant points) of structure 71 at which the accelerometric sensors 62a, 62b, 62c, 62d are positioned; the displacements of the significant points of structure 11 are obtained, once the accelerations (which are known as they are measured by the accelerometric sensors 62a, 62b, 62c, 62d) and the instants at which they were measured are known, by carrying out a dual integration in the time domain of the time histories of the accelerations.

From the calculation of the displacements of the significant points of structure 71, the relative displacements between the horizontal elements 81, 82, 83 present in structure 71 and the relative displacements between foundation 84 and the horizontal element 83 are then calculated, among others.

The values of the inter-story displacements occurred during the seismic event, as is known, (usually) constitute a very important information to assess the condition of structure 71 after a seismic event.

It was mentioned above that each of the two acquisition units 63a, 63b stores all the data transmitted by the eight accelerometric sensors 62a, 62b, 62c, 62d connected thereto. In this case, therefore, no storage strategy aimed to only store data considered potentially critical is contemplated. Each of the two acquisition units 63a, 63b stores all the data it receives, at the same time also storing the instants at which such data is measured. Each of the two acquisition units 63a, 63b, during the operating life of structure 71, before storing new data in its mass memory, deletes the least recent data from its mass memory.

As an example, consider that the mass memory of each of the two acquisition units 63a, 63b has a memory capacity adapted to contain all the data transmitted by the eight accelerometric sensors 62a, 62b, 62c, 62d connected thereto, in a time interval of ten days. Let's consider, for example, the acquisition unit 63a. The acquisition unit 63b behaves (from this point of view) like the acquisition unit 63a.

The acquisition unit 63a, starting from the start-up instant, stores the data coming from the eight accelerometric sensors 62a, 62b, 62c, 62d connected thereto according to the predetermined sampling frequency and also stores the instants at which it has been measured; this continues for the first ten days, starting from the start-up date of the seismic monitoring system 60. Thereafter, at the beginning of the eleventh day, the acquisition unit 63a, which now has no more space available in its mass memory, deletes the data of the first day and stores the data of the eleventh day. Thereafter, at the beginning of the twelfth day, the acquisition unit 63a, which has no more space available in its mass memory, deletes the data of the second day and stores the data of the twelfth day; and so on. Therefore, the data of the day considered and the data of the preceding nine days of measurements is available on any day in the mass memory of the acquisition unit 63a.

If, for example, a seismic event occurs (this event is perceived by those working in building 70; the presence of such seismic event is then confirmed and also disclosed by the media) on the hundredth day since the start-up of the acquisition unit 63a (or better of the seismic monitoring system 60), when such seismic event occurs, the data measured in the time interval comprised between ninety and hundred days, measured since the start-up of the acquisition unit 63a, is present in the mass memory of the acquisition unit 63a.

After the seismic event, for example three days after such event, and this on the one hundred and third day since the date of start-up of the acquisition unit 63a, the manager of building 70 extracts, from the mass memory of the acquisition unit 63a, the data stored therein; more precisely, the manager of building 70 extracts the mass memory from the acquisition unit 63a (such mass memory consists of a USB key) and immediately introduces a new mass memory equal to that just extracted. Said mass memory, when it is extracted, contains the data measured between the one hundred and third day and the ninety and third day (ten days prior to the one hundred and third day); therefore, the data of the hundredth day, when the seismic event occurred, is also included. From the above description it is clear that, if the manager of building 70 waited more than ten days since the date of the seismic event on the hundredth day (therefore, if he waited past the one hundred and tenth day), he would not find the data from the hundredth day anymore and would therefore lose the data relating to the seismic event.

The method for carrying out the seismic monitoring (of structure 71) using the seismic monitoring system 60 (comprising the sixteen accelerometric sensors 62a, 62b, 62c, 62d and the two acquisition units 63a, 63b) comprises operations technically equivalent to the operations relating to the method for carrying out the seismic monitoring (of structure 11) using the seismic monitoring system 1 described above.

According to a possible embodiment variant, in place of the sixteen mono-axial accelerometric sensors 62a, 62b, 62c, 62d, eight two-axial accelerometric sensors or even eight triaxial accelerometric sensors may be used, the latter allowing the acquisition of data relating to the vertical component of the seismic acceleration.

According to a possible embodiment variant, not shown in the figures, it is possible to use a single acquisition unit in place of the two acquisition units 63a, 63b. In this case, the performance of such acquisition unit must be such as to be able to connect with the sixteen accelerometric sensors 62a, 62b, 62c, 62d and such as to be able to convert the analog signals into digital data and to be able to then process the digital data.

With reference to the seismic monitoring system according to the invention, the following is noted.

A seismic monitoring system obtained according to the present invention (such as the seismic monitoring systems 1, 30, 60), once activated operates automatically, carrying out the necessary checks and the necessary maintenance, throughout the useful lifetime of the structure (apart, of course, from the downtime due to such checks and to such maintenance); it measures, throughout the lifetime of the structure on which it is installed, the accelerations of significant points of the structure itself. The seismic monitoring system is temporarily disabled only to carry out maintenance and possible replacement of malfunctioning equipment.

It is noted that inspections and checks must be carried out, with predetermined frequency, to ensure the proper functioning of the components of the seismic monitoring system.

It is noted that usually, in case of seismic event, the data stored in the one or more acquisition units is processed to identify the values of the displacements of the significant points of the structure at which the accelerometric sensors are installed.

The data transmission from the seismic monitoring system (installed at the structure of a building) to the external computer (which may be (for example) a computer of a data processing center or the computer of the engineer in charge of verifying the building after the seismic event) by which the displacements of the significant points of the structure are calculated takes place by direct intervention of an operator (such as, for example, the building manager).

Data retrieve from the mass memory of the one or more acquisition units (comprised in the seismic monitoring system considered) is carried out by extracting the mass memory itself of the acquisition unit considered; it is noted that in these cases, the mass memory consists of a USB key or a hard disk. The manager of the building, after extracting said USB key, inserts another USB key, equivalent to the previous one, in said acquisition unit. It is noted that such components and methods may be provided that the acquisition unit continues to acquire data continuously, also during the extraction step of the mass memory of the acquisition unit itself, and also during the time interval between the extraction of said mass memory (USB key) and the insertion of an equivalent extractable mass memory (another USB key which in this case has an empty memory) in the data acquisition unit considered.

In relation to the typical use of the seismic monitoring system obtained according to the present invention, the following is noted.

Let's consider a building whose structure is monitored by a seismic monitoring system obtained according to the present invention.

Let's assume (for example) that such building is made up of a three-story building made of reinforced concrete cast on site and let's assume, then, that each horizontal element (deck) is monitored using two triaxial accelerometric sensors (mutually placed at a distance comparable to the maximum plan dimension of the building) and that the foundations are also monitored by means of two accelerometric sensors integral thereto. Moreover, let's assume that a “significant” seismic event occurs in the area in which such a building is located. Such seismic event is perceived by the inhabitants of the area concerned, and therefore also by those who occupy the building; this seismic event is then mentioned by the media (television, the Internet, newspapers, etc.).

During the seismic event, the seismic monitoring system measures and stores the accelerations of significant points of the structure at which the accelerometric sensors are positioned.

According to a first way of proceeding, part of the method for carrying out the seismic monitoring of a structure according to the present invention, after the seismic event a building manager extracts the data stored by the one or more acquisition units and transmits it, for example via the Internet, to the engineer in charge of verifying, after the seismic event, the building and, in particular, the structure of the building itself. Said engineer processes these data (which constitute the time history of the accelerations of said significant points of the structure measured by the seismic monitoring system) by means of a computer in his possession (such computer is the external computer mentioned above) and identifies the values of the displacements occurred during the seismic event, of the points of the structure at which the accelerometric sensors have been positioned. The engineer then calculates the relative displacements between the significant points of the structure.

Moreover, said engineer carries out one or more inspections on the building and carefully examines the building and, in particular, the structure.

It is noted that, in order to process the data measured and thus be able to calculate the displacements of the significant points of the structure, starting from the accelerations, the engineer needs a calculation program (which may also be a calculation procedure supported by a of commercial calculation program) which, using said computer, executes the dual integration in the time domain of the time histories of accelerations acquired and stored by the seismic monitoring system. It is noted that in the calculations must use special filters (implemented by numerical calculation) by following the instructions provided with the seismic monitoring system at the time of its installation at the structure of said building. The values of the displacements of said significant points of the structure are valuable information to identify the dynamic response of the structure subjected to the seismic event and to assess the state of damage of the structure after the seismic event.

It is noted that, considering the measurements of the accelerometric sensors placed at the foundations of the structure, the engineer can identify the values of the accelerations undergone by parts of the structure (foundations) in contact with the ground and, in particular, he can identify the maximum value of the accelerations that have occurred both in the horizontal plane and in general, in the vertical plane.

According to an alternative way of proceeding, part of the method for carrying out the seismic monitoring of a structure according to the present invention, the building manager, after a seismic event, extracts the data from the mass memory of the one or more acquisition units and sends it, for example via the Internet, to a data processing center provided with a computer provided with a calculation program adapted to execute the dual integration in the time domain of the time histories of the acceleration, thus obtaining the time histories of the displacements. In this case, the external computer mentioned above is said computer in the data processing center. It is noted that in this case, therefore, the manager of the building does not directly send the data taken from the mass memory of said one or more acquisition units to the engineer (in charge of carrying out the post-earthquake verification of the building). This data processing center, once the time histories of the displacements of the significant points of the structure have been calculated, and once the time histories of the accelerations of the above points have been set in a certain format, forwards such results to the building manager. The building manager then sends all the data and results to the engineer in charge of verifying the structure after the seismic event.

In each of the two cases described above, the data stored by the seismic monitoring system and suitably processed (as described above) is available to the engineer in charge of verifying the building after the seismic event.

It is noted that the values of the displacements of said points (which are significant points) of the structure (reference is made to the types of structures 11, 41, 71 and to similar types) (usually) constitute valuable information for identifying the dynamic response of the structure subjected to the seismic event.

The importance of having the data provided by the seismic monitoring system and by the subsequent processing in order to be able to correctly define the state of damage of the structure due to the seismic action is clear. It is noted that usually, knowing these values also allows assessing (with the inevitable approximations) which the maximum deformation (and stresses) undergone by the structural elements present were, and therefore also the possible need to restore the same.

These statements presuppose that the accelerometric sensors have been positioned, according to the design of the seismic monitoring system made before its installation, in points that are actually significant for the structure, i.e. in points whose displacements are characteristic of the state of damage of the structure, according to the ductile failure mechanisms identified by the designer.

It is noted that the external computer (be it that of said data processing center, be it that of the engineer) does not automatically or “specifically” communicate with the seismic monitoring system, but is only provided with calculation programs immediately usable for processing the data acquired and stored by any of the seismic monitoring systems obtained according to the present invention.

The time histories of the displacements, starting from the time histories of the accelerations, are obtained using “any” computer external to the monitored structure provided with a calculation program that executes the dual integration of the time histories measured over time. Moreover, the data measured by from a plurality of seismic monitoring systems can be processed (one after the other) by a single or a small number of “external” computers.

In order calculate the time histories of the displacements of the significant points of the structure starting from the time histories of the accelerations of said points, no specific calculation model of the structure (e.g. a finite element model) is needed.

It is noted that the external computer (be it that of said processing center, be it that of the engineer), for calculating the displacement of the significant points of the structure does not need to use a calculation model of the structure. Of course, the engineer must have adequately detailed knowledge of the structure, materials used, construction details, etc., and must usually prepare one or more mathematical models to interpret, based on the data in his possession, the behavior of the structure subjected to the seismic event and to identify, with sufficient approximation, the condition of the structure itself (in particular the possible state of damage) after the seismic event itself.

It is noted that one of the advantages of the seismic monitoring system obtained according to the present invention consists in that, in order to know the values of the displacements of the significant points of the structure over time, there is no need to refer to a specific computer that “knows” the structure at which the seismic monitoring system is installed and which communicates specifically with it.

It is also noted that, in order to process the data from the mass memory of the one or more acquisition units, any “generic” computer provided with (also commercial) software adapted to execute a dual integration over time of the time histories of the accelerations measured and stored by the seismic monitoring system is sufficient, taking into consideration the necessary filters to be introduced into the calculation.

The engineer in charge of the post-earthquake verifications, once all the necessary verifications relating to the building and in particular to its structure have been carried out, decides what to do.

A first situation that may occur is when said engineer (having carried out the necessary verifications concerning the building and in particular the structure of the building itself) authorizes the occupants to return into the building itself.

A second situation that may occur is when the engineer does not authorize the occupants to return into the building and gives instructions to carry out works to restore the expected levels of security.

A third situation that may occur is when said engineer declares that the building can no longer be used and orders the demolition of the building itself.

If one considers the above description, it is clear that the time necessary to be able to reuse the building after a seismic event, even in the case of the first one of the three options described above, is not in practice related to the response of the seismic monitoring system installed in the structure, but to the engineer who must comprehensively assess the situation of the building using, of course, other parameters in addition to those measured. Even if the results of data processing were ready a few minutes after the seismic event, not much time would usually be saved and the advance with which the occupants of the building could return inside would not be meaningful. It is noted that the data collection process and data processing on an “external” computer (at the data processing center itself or at the engineer in charge of the post-earthquake verification) may usually take place in a tight timeframe.

It is noted that the seismic monitoring system obtained according to the present invention does not provide real time responses.

The actual needs for real time response are restricted, in practice, only to a few cases and a few buildings, such as the strategic buildings necessary for the community in the event of a seismic event, for which the situation in which they are after the seismic event must be known “immediately”. For most of the buildings located in an area struck by a seismic event, the response in real time is not essential and is, in any case, very difficult to obtain.

What always has great interest is to know, as much as possible, what actually happened during the seismic event. If reference is made to buildings with “stringer” structures of reinforced concrete or steel, it is usually very important to know the relative displacements of the various horizontal elements (decks), the relative displacements between such horizontal elements and in particular, the relative displacements (possibly) story by story, between the upper end and the lower end of the columns of each inter-story in the building. These relative displacements are obtained from the values of the accelerations measured by the accelerometric sensors installed on the structure. Once again, the need to have time-related data available and to be able to ensure the “concurrence” of the measurements of all the accelerometric sensors connected to the one or more acquisition units is noted.

Generally speaking, with a seismic monitoring system obtained according to the present invention, both existing buildings and new buildings can be monitored. In particular, buildings whose structure is made of reinforced concrete pillars and beams and of horizontal elements made using concrete can be monitored. It is noted that buildings with prefabricated reinforced concrete beams, columns and horizontal elements can be advantageously monitored.

In order to implement a seismic monitoring system according to the present invention it is of course necessary to know the structure to be monitored with adequate accuracy. It is also necessary that the displacements of the points of the structure at which the accelerometric sensors are placed are significant for the purposes of the response of the structure to the seismic action and are such as to be indicative of the state of damage of the structure. Moreover, the structure must be such or be made such as to not exhibit early brittle failures, or in any case possible partial and global collapse modes, not directly related to said values of the displacements of the significant points.

Considering, for example, the case of a structure like the one shown in the present description, the horizontal displacements of the decks are significant; knowing such displacements, if the decks can be considered rigid in their plane, it is possible to obtain the displacements of the ends of all the pillars integral to the decks themselves.

If the decks cannot be considered rigid, in order to know the values of the displacements of the ends of the pillars, it is necessary to increase the number of accelerometric sensors to be used.

It is noted that in the present description and in the following claims, the expression “accelerometric sensor” refers to both an instrumentation that includes, as in the case of the accelerometric sensors 2a, 2b, 32a, 32b, one or more accelerometers, a microprocessor (which, among other functions, also transforms the analog signals from said one or more accelerometers into digital data), a temperature sensor and other components, and an instrumentation that (substantially only) consists of an accelerometer (which transmits analog signals), as in the case of the accelerometric sensors 62a, 62b, 62c, 62d.

The installation of a seismic monitoring system obtained according to the present invention is subject, among other things, also to the verification that the expected accelerations at the measuring points fall within the range of values such as to properly measured by the seismic monitoring system (and in particular by the accelerometric sensors comprised therein) and such as to be used for defining the time history of the displacements of said significant points.

The seismic monitoring system obtained according to the present invention essentially has the function of “black box” normally used in the case of means of transport such as aircraft, ships, etc. In such “black box”, in the case of the present invention, information is recorded that allows reconstructing, at the points at which the accelerometric sensors are positioned, the response, in terms of accelerations and displacements of the structure to the seismic event or in any case to dynamic stresses. It is noted that, in the case (which can be expected to be very common) in which each of the one or more acquisition units stores to its mass memory only part of the data measured by the accelerometric sensors (as well as the acquisition units 3, 33a, 33b), differences exist between the “storage mode”, and thus between the functioning, of the one or more acquisition units and the “storage mode” and thus the functioning, of the typical “black box” that (usually) records all the data that it is designed to record, without making choices regarding the “criticality” of the data received.

If the seismic monitoring system obtained according to the present invention is compared with the prior art seismic monitoring systems, the following may be observed. In the seismic monitoring system according to the present invention there are no seismic recognition systems since recognizing that a seismic event (of significant intensity or even simply “detectable”) occurred in a certain area results from the direct perception of the seismic event by the inhabitants of that area and from the “public” information (written in newspapers or on the web, or communicated by means of television) which certainly give information about the seismic event.

In this context, an actual “recognition” of the seismic event by an automatic system is not needed since the seismic event is “recognized” and highlighted; once it is known that a “significant” seismic event has occurred, an operator (the manager of the building mentioned above) extracts the data from the mass memory of the one or more acquisition units and transmits it, for example through the Internet, to an external computer (that is, external to the seismic monitoring system) provided with software adapted to execute the dual integration over time of the time history of the accelerations measured by the accelerometric sensors.

It is noted that the typical usage of data provided by a seismic monitoring system obtained according to the present invention falls within the procedures traditionally adopted for the verification of structures after a seismic event. In fact, after a seismic event, the building at which the seismic monitoring system is installed is immediately evacuated; thereafter, it is possible to return into the building if and when the engineer in charge of carrying out the verifications of the building after the seismic event, having carried out the necessary inspections and taking into consideration the data obtained from the seismic monitoring system, finds that the building, and in particular the structure thereof, substantially has not been damaged or otherwise has not undergone such damage to prevent the immediate reuse of the building.

The intelligence of the seismic monitoring system obtained according to the present invention is reduced compared to the intelligence needed to many other “technically equivalent” monitoring systems present in the prior art. It is noted that, in spite of such “simplicity” and in the lack of a processing unit included in the seismic monitoring system itself, the results obtained by processing the data from the acquisition units are characterized by remarkable accuracy and reliability, in the context of the hypotheses, criteria and conditions under which one must operate.

It is noted that the “loss” of the “real time response” performance (the response in real time, often, is not essential) is in many cases, in practice, easily surmountable.

The seismic monitoring system obtained according to the present invention allows acquiring data that is usually very important to assess the seismic response of the structure subjected to a significant seismic event. The seismic monitoring system allows obtaining the “actual (as measured)” values of the displacements during the earthquake of the points of the structure at which the accelerometric sensors are installed. These data, together with many other data concerning the building under consideration and in particular, its situation after the seismic event, allow the engineer (carrying out the verification of the building after the earthquake) to make more informed and documented decisions concerning the building considered and, in particular, concerning the structure of said building.

The following is noted.

Some seismic monitoring systems according to the prior art include data processing units that are placed inside the building monitored; other seismic monitoring systems according to the prior art transmit the data measured to remote computer with which such seismic monitoring systems communicate; specific software is present in such remote computers related to the equipment installed in the buildings to be monitored.

These seismic monitoring systems can automatically send messages to preset addresses that characterize the results of the measurements and calculations made.

All the aforementioned seismic monitoring systems present in the prior art do not meet the “current” widespread need for a cost-effective but highly effective instrument that records the accelerations of the significant points of the structure and that, by processing the data itself, allows knowing, in addition to the accelerations, the displacements of said significant points of the structure.

The accelerometric sensors used in a seismic monitoring system according to the present invention can be varied and can be provided with different features, all falling within the scope of the present invention: in particular, each accelerometric sensor may comprise various components, as well as one or more accelerometers; in particular, there may be one or more so-called “main” microprocessors and one or more control microprocessors that allow checking the correct functioning of the one or more main microprocessors, a temperature sensor, an orientation sensor, etc.

Moreover, the accelerometers may belong to different types and they may be, for example, of capacitive or piezoelectric type, or even other types.

A seismic monitoring system obtained according to the present invention comprises instruments and equipment which acquire and store in one or more mass memories (comprised in one or more acquisition units, respectively; each acquisition unit comprises a mass memory) or only data considered as “significant” for the purposes of the seismic detection or all the data transmitted thereto by the accelerometric sensors.

After a seismic event, the building manager's task is to retrieve the data from the one or more acquisition units and transmit the data stored in the one or more acquisition units forming part of the seismic monitoring system of the building itself to the engineer in charge for verifying the building.

It is noted that, if the manager of the building sends the acceleration measurements carried out by the accelerometric sensors and the instants at which such measurements were carried out directly to the engineer, the engineer is generally provided also with the data of the filters (implemented with numerical calculations) to be used for the calculation of the displacements of the significant points of the structure. Among the data transmitted by the manager of the building to said engineer are also the drawings related to the project of the seismic monitoring system with the location, name and orientation of all the accelerometric sensors (as well as of the one or more acquisition units).

In practice, the seismic monitoring system obtained according to the present invention either stores (with the one or more acquisition units) the data (from the accelerometric sensors) that have an “anomaly” (as they are higher than predetermined threshold values established during the design and installation of the seismic monitoring system itself) or stores all the data from the accelerometric sensors (irrespective of whether they have or not said “anomalies”). It is predictable that, in some cases, such anomalies are due to dynamic actions not related to a seismic event; this does not create any major problems since the identification of “abnormal” signals, as described above, has the only effect of storing such data in the mass memory of the one or more acquisition units.

The one or more acquisition units do not recognize the seismic event; the seismic event is recognized and identified either by public seismic detection systems and/or simply by the inhabitants of the area affected by the seismic event.

In a seismic monitoring system obtained according to the present invention, each of the one or more acquisition unit is placed within containers that can withstand even extreme load conditions. This feature makes them suitable to work even if, during the seismic event, detachments of parts of the building (such as finishing elements, shelving, etc.) occur which hit such containers. In general, moreover, such one or more containers (with the one or more acquisition units therein) are placed in peripheral parts of the building, still easily accessible or, preferably, they are placed outside the building, even at some distance from it.

Such containers, in any case, are provided with water tightness features and are such as not to allow the penetration of dust; such containers are provided with access doors, also provided with suitable resistance and safety features.

A seismic monitoring system obtained according to the present invention usually comprises a redundant number of accelerometric sensors. In fact, during the seismic event, damage may in some cases occur to some of the accelerometric sensors integral with the structural elements so that, in order to ensure that data is acquired and stored in such a number as to be able to reconstruct, for example, the displacements of a horizontal element, it is important that a number of accelerometric sensors is installed at such a horizontal element higher than the strictly necessary minimum number. Particular care is necessary in laying the path of the communication lines (and therefore of the cables) that connect the various components of the seismic monitoring system.

A seismic monitoring system obtained according to the present invention is applied to a structure of which the possible collapse mechanisms, which must be ductile mechanisms, are known in advance; to this end, it is necessary that, in such structure, compliance is ensured with the criteria of the resistance hierarchy and that the construction details that ensure the ductile behavior of the structural elements adapted to withstand the seismic actions are properly designed and executed (according to the provisions of the civil engineering rules related to structures located in seismic areas).

It is noted that in the case of structures 11 and 41, which are made with prefabricated earthquake-resistant elements having the static scheme of rods joined to the base and hinged at the top, the ductile failure mechanisms possible provide for the formation of plastic hinges in the areas of the rods (of pillars) close to the foundations. Due to such plastic hinges, significant relative displacements occur upon the collapse between the base and the top of said rods (of the pillar). It is noted that the formation of plastic hinges at the ends of the pillars is typical of prefabricated structures (with pillars joined to the base and beams connected to the pillars by means of constrains that can be schematized as hinges), like the prefabricated structures 11 and 41.

It is noted that, in the structures described in the present description, the vertical earthquake-resistant structural elements consist of pillars and baffles; however, it is in general possible to install a seismic monitoring system obtained according to the present invention also at structures comprising other types of structural elements (in addition to or in replacement of pillars and baffles).

In order to ensure the continuous operation of the seismic monitoring system also in case of electricity supply failure, a UPS (such as UPS 6) is usually used. In addition to the UPS, a generator may be used (such as generator 12), connected to the UPS; the generator is automatically activated when the electricity supply failure from the mains continues for a time interval that is longer than a predetermined value (e.g. 10 minutes); the generator, therefore, allows the seismic monitoring system to work for an extended period without electricity supply from the mains.

A seismic monitoring system according to the present invention can be installed at the structure of a new building; in this case, said seismic monitoring system is operational since the commissioning of the building itself.

A seismic monitoring system obtained according to the present invention can also be installed at the structure of an existing building.

It is noted that a seismic monitoring system obtained according to the present invention can be installed at the structure of a building which comprises prefabricated structural elements of reinforced concrete and/or prestressed reinforced concrete.

If the seismic monitoring system according to the present invention is applied to an existing building (as in the case of building 70), prior to application of the seismic monitoring system itself, it is necessary to identify all possible failure mechanisms of the building structure. It is clear that this implies, among other things, the accurate knowledge of the geometrical and mechanical characteristics of the structure as well as the characteristics of the ground on which the building stands. It is also necessary to design and execute renovation works such as to prevent the occurrence of brittle failure mechanisms.

Once the existing building has thus been renovated, eliminating the possible brittle failure mechanisms, the seismic monitoring system according to the present invention is designed and installed.

A seismic monitoring system obtained according to the present invention preferably comprises triaxial accelerometric sensors, although it can also comprise only monoaxial accelerometric sensors.

It is noted that the seismic monitoring system obtained according to the present invention is a very useful instrument which provides objective knowledge to the engineer that needs to assess the situation of the building after a seismic event.

It is noted that, in the absence of the seismic monitoring system, the assessment of the maximum relative displacements is carried out, in a necessarily highly approximate manner, by observing “a posteriori” the effects caused by such relative displacements.

It is noted that the only way to know “exactly” the value of the maximum displacements of the significant points of the structure is to measure them while they are occurring, that is, during the seismic event.

It is also noted that the seismic monitoring system allows knowing the values of the displacements of parts of structures that are hidden by non-structural construction elements such as finishing elements, false ceilings, etc.

The present description has described cases above where the data storage strategy in the one or more acquisition unit provides for the identification of critical data packets that identify, with their presence, time intervals of suitable duration, during each of which the one or more acquisition units store “continuously” (meaning: for the entire duration of the time interval considered) all the data transmitted thereto by the accelerometric sensors. A case has also been described in which data storing always takes place continuously. It is noted that in each of the cases mentioned above, depending on the capacity of the mass memory of the acquisition unit considered, the acquisition unit itself stores the most recent data and deletes the least recent (oldest) data. It is noted that different criteria may be used, other than those shown, adapted to identify the intervals at which the one or more acquisition units must store the data.

If the cables connecting the accelerometric sensors to the acquisition units (such as cables 5, 35, 65) or the cables connecting the acquisition units to one another are particularly long, signal repeater elements are introduced along the lines.

An advantage of the present invention lies in the fact that the seismic monitoring system obtained according to the present invention provides “real” measurements (meaning: “actually occurred during the seismic event”) of the relative displacements between significant points of the structure.

Such measurements are the “objective” and “provable” basis of the assessments of damage to the structure and provide a useful tool to understand and assess the situation of the building after the seismic event.

A further advantage of the present invention is that the data gathered by the seismic monitoring system can be used, if coordinated and studied alongside that of other “similarly monitored” buildings, to increase the knowledge of the behavior of structures subjected to seismic actions.

A further advantage of the present invention is that the data gathered by various seismic monitoring systems (obtained according to the present invention) installed on buildings located in a predetermined area can be used, suitably studied and correlated, to increase the knowledge of said area and of the structures located in the area itself in the seismic context.

1. A seismic monitoring system installed at a structure of a building, said structure being such that brittle failure mechanisms are prevented therein and only ductile failure mechanisms are possible, said seismic monitoring system, comprising:
a plurality of accelerometric sensors positioned at significant points of the structure;
one or more acquisition units to which said accelerometric sensors are connected; each of said one or more acquisition units continually receives the data coming from the accelerometric sensors connected thereto;
the seismic monitoring system, once installed at the structure and once activated, functions continually, except for the pauses due to maintenance or replacement of components, for the entire useful lifetime of the structure,
such seismic monitoring system characterized in that the accelerometric sensors measure, with a predetermined frequency, the values of the accelerations of the points of the structure at which said accelerometric sensors are positioned; one of the one or more acquisition units synchronizes the measurements of all the accelerometric sensors comprised in the seismic monitoring system indicating to all the accelerometric sensors the instants at which these must carry out the measurements (of acceleration);
each of the one or more acquisition units comprises, in addition to a RAM memory, a mass memory in which at least part of the data is stored that is measured by the accelerometric sensors connected to said acquisition unit and transmitted by said accelerometric sensors to said acquisition unit; in said mass memory, the instants are also stored at which such data has been measured; said mass memory is extractable;
each of the one or more acquisition units preserves, in its mass memory, only the most recent data, canceling the less recent data before introducing new data;
each of the one or more acquisition units also provides the necessary electrical energy for the accelerometric sensors connected thereto;
said seismic monitoring system, if said structure is subjected to seismic actions, is adapted to be used so to be able to identify, in addition to the accelerations, also the displacements of said points of the structure at which the accelerometric sensors are positioned; said displacements are obtained by processing, executed after the seismic event, of the acceleration measurements carried out by said accelerometric sensors; said processing is carried out by an external computer that is not part of said seismic monitoring system and which is situated outside the monitored structure.

2. The seismic monitoring system according to claim 1, wherein, if the seismic monitoring system comprises more than one acquisition unit, one of said acquisition units is the master acquisition unit and the one or more remaining acquisition units are the slave acquisition units;
each of the one or more slave acquisition units and the master acquisition unit are connected to the relative one or more accelerometric sensors; the one or more slave acquisition units are connected to the master acquisition unit;
the master acquisition unit synchronizes the measurements of all the accelerometric sensors comprised in said seismic monitoring system, indicating to all the accelerometric sensors the instants at which they must carry out the measurements of acceleration; the synchronization is actuated by using signals sent, by a specific data transmission line, from the master acquisition unit to the one or more accelerometric sensors comprised in said seismic monitoring system.

3. The seismic monitoring system according to claim 2, wherein each of the one or more slave acquisition units transmits the data already stored in its mass memory to the master acquisition unit, which stores it in its mass memory, in addition to the data already stored in said mass memory measured by the accelerometric sensors directly connected to the master acquisition unit.

4. The seismic monitoring system according to claim 1, wherein each of the one or more acquisition units and the relative accelerometric sensors are connected to each other by a CAN bus network (CAN stands for: Controller Area Network).

5. The seismic monitoring system according to claim 1, wherein one or more CAN bus lines are connected to each of the one or more acquisition units; a plurality of accelerometric sensors is connected to each of said one or more CAN bus lines.

6. The seismic monitoring system according to claim 1, wherein each of the one or more acquisition units and the relative accelerometric sensors are connected to each other by means of data transmission lines comprising one or more CAN bus lines on which the data is transmitted that is measured by the accelerometric sensors, a synchronization line which is a specific line by which the instants are indicated at which the accelerometric sensors must carry out the measurements, and an error signal transmission line which is a specific line for the transmission of the malfunctioning messages; each of said one or more acquisition units is connected to the relative accelerometric sensors also by an electrical line by which said acquisition unit power supplies the accelerometric sensors connected thereto.

7. The seismic monitoring system according to claim 1, wherein the acquisition units are connected to each other by means of data transmission lines comprising a first synchronization line which is used for synchronizing all the accelerometric sensors, a second synchronization line which is used for synchronizing the instants at which all the two or more acquisition units begin to form data packets and a line for signaling the critical data packets.

8. The seismic monitoring system according to claim 1, wherein each accelerometric sensor comprises one or more accelerometers, a main microprocessor, a control microprocessor, a temperature sensor, a CAN bus driver, an error signaling circuit, a clock signal input circuit, two connectors adapted to connect the considered accelerometric sensor to the CAN bus network and to other data transmission lines, a power supply unit and a containment element, within which all the above-listed components are positioned; said main microprocessor, among other things, also transforms the analog signals received from said one or more accelerometers into digital data and carries out controls at least relative to the functioning of said one or more accelerometers.

9. The seismic monitoring system according to claim 1, wherein each of the one or more acquisition units comprises a microprocessor, a system of communication with the user, a RAM memory, a mass memory in which at least part of the data is stored that is transmitted by the accelerometric sensors connected to said acquisition unit, a clock generator, a USB bus driver for managing the mass memory, an input circuit for the error messages coming from the accelerometric sensors, connectors for connecting with one or more CAN bus lines and for the possible connection with other acquisition units comprised in the aforesaid seismic monitoring system, a transformer and a power supply unit; said mass memory is extractable.

10. The seismic monitoring system according to claim 1, wherein the extractable mass memory is constituted by a USB key.

11. A method for carrying out the seismic monitoring of a structure on which a seismic monitoring system according to claim 1 is installed, wherein it provides for the following operations:
execution, by the accelerometric sensors, of the acceleration measurements of the points of the structure at which said accelerometric sensors are positioned; each accelerometric sensor transmits, in real time, the measurements carried out to the acquisition unit with which it is connected; said measurements are carried out, with a predetermined frequency, at the instants indicated to said accelerometric sensors by one of the one or more acquisition units comprised in the seismic monitoring system;
acquisition, by each of the one or more acquisition units, of the data measured by the accelerometric sensors connected thereto and storage, by each of the one or more acquisition units, in its mass memory, which is extractable, of at least part of the data measured by the accelerometric sensors connected to said acquisition unit and transmitted thereto; each of said one or more acquisition units stores in its mass memory, in addition to said at least part of the values of the accelerations measured by the accelerometric sensors connected thereto, also the instants at which they are measured;
retrieve, after a seismic event that affects said structure, of the data stored by said one or more acquisition units; said retrieve is carried out by turning on the mass memory of at least one acquisition unit and extracting said mass memory from said at least one acquisition unit;
transfer of said stored (and retrieved) data to an external computer that is not part of said seismic monitoring system and which is situated outside the monitored structure; by said external computer, starting from the time histories of the accelerations of the points of said structure in which the accelerometric sensors are positioned, the time histories of the displacements of said points of the structure are calculated.

12. The method according to claim 11, wherein said retrieve is carried out entering the mass memory of each of the one or more acquisition units comprised in the seismic monitoring system and extracting said mass memory from each of said one or more acquisition units.

13. The method according to claim 11, wherein said retrieve and said transfer of the data are carried out with manual operations.

14. The method according to claim 11, wherein each of the one or more acquisition units, in order to store, in its mass memory, only part of the data transmitted thereto by the accelerometric sensors connected thereto, substantially carries out, in real time, a processing of said data.

15. The method according to claim 11, wherein, if the seismic monitoring system comprises, in addition to accelerometric sensors, only one acquisition unit, said acquisition unit carries out said processing of the data by dividing the data received from said accelerometric sensors into data packets and calculating the reference parameters, relative to the data contained in each of said data packets, in order to identify, by following predetermined criteria, whether the values of such parameters are greater than predetermined threshold values; if this happens, and hence if the examined data packet is identified as “critical”, the acquisition unit stores, in its mass memory, such data packet and a predetermined number of data packets which precede the data packet that it is processing, maintained in the RAM memory of said acquisition unit; said acquisition unit continues the storage of the data transmitted by the accelerometric sensors for a sufficiently long time, measured starting from the instant at which said acquisition unit identified the last critical data packet.

16. The method according to claim 11, wherein, if the seismic monitoring system comprises, in addition to accelerometric sensors, only one acquisition unit, said acquisition unit continuously divides, according to a predetermined frequency, the data measured by the accelerometric sensors into data packets, all composed of a same predetermined number of data; let t₁ be the instant at which the formation of a generic data packet begins and let t₂ be the instant at which the formation of said data packet terminates, it follows that the time interval in which said data packet is formed is equal to t₂−t₁; said time interval has same value and remains such over time for all the data packets;
at the instant t₂ᵢ, in which the i-th data packet is completed, the i-th data packet and the last (most recent) N data packets formed immediately before the i-th data packet are present in the RAM memory of the acquisition unit, N being a predetermined integer;
each data packet comprises a set of data groups; each data group relates to one of the one or more components of the acceleration measured by an accelerometric sensor (which is connected to the acquisition unit); the number of the data groups comprised in a generic data packet is, therefore, equal to the number of the accelerometric sensors connected to the acquisition unit, multiplied by the number of the components of the acceleration measured by each of said accelerometric sensors;
the acquisition unit, after having formed the i-th data packet, proceeds with the formation of the subsequent data packet and processes the data of said i-th data packet; in particular said acquisition unit processes the data of each of said data groups comprised in said i-th data packet, in order to identify whether at least one of said data groups is to be considered critical;
if all said data groups comprised in said i-th data packet result non-“critical”, the acquisition unit does not store, in its mass memory, the data of said i-th data packet;
if even only one of said data groups, being part of said i-th data packet, results critical, the acquisition unit stores, in its mass memory, the data contained in said i-th data packet which is identified as “critical data packet”;
the acquisition unit also stores, in its mass memory, the N data packets present in the RAM memory thereof that were previously formed; said data packets are those immediately preceding said critical data packet;
the acquisition unit continues to store, in its mass memory, all the data transmitted by the accelerometric sensors (connected thereto) and continues to form the data packets and to process the data of each of said data packets, in order to identify the critical data packets; the acquisition unit interrupts the storage of the data in its mass memory only after a predetermined time interval has passed (equal to J times the time interval in which each data packet is formed) during which the acquisition unit has detected no critical data packet, J being a predetermined integer.

17. The method according to claim 11, wherein, if the seismic monitoring system comprises, in addition to accelerometric sensors, more than one acquisition unit synchronized with each other, one acquisition unit is the master acquisition unit and each of the remaining one or more acquisition units is a slave acquisition unit; the master acquisition unit synchronizes itself and the one or more slave acquisition units;
each acquisition unit carries out said processing of the data by dividing the data received by the accelerometric sensors connected thereto into data packets (whose formation is synchronized by the master acquisition unit) and calculating reference parameters, relative to the data contained in each of said data packets in order to identify, following predetermined criteria, whether the values of such parameters are greater than predetermined threshold values; if this happens, and hence if the examined data packet is identified as “critical”, the considered acquisition unit stores, in its mass memory, said data packet and a predetermined number of data packets which precede the data packet that it is processing, maintained in the RAM memory of said acquisition unit; in addition, said acquisition unit communicates, in real time, the presence of said critical data packet to each of the other one or more acquisition units;
each of said other one or more acquisition units then stores, in its mass memory, the data packets present in the RAM memory thereof;
each acquisition unit comprised in said seismic monitoring system continues storing the data transmitted by all the accelerometric sensors connected thereto for a sufficiently long time, measured starting from the instant at which a critical data packet has been identified by any one of said acquisition units.

18. The method according to claim 11, wherein, if the seismic monitoring system comprises, in addition to accelerometric sensors, more than one acquisition unit, one acquisition unit is the master acquisition unit and each of the remaining one or more acquisition units is a slave acquisition unit;
each acquisition unit continuously divides, according to a predetermined frequency, the data measured by the accelerometric sensors connected thereto into data packets, all composed of a same predetermined number of data;
let t₁ be the instant at which the formation of a generic data packet begins and let t₂ be the instant at which the formation of said data packet terminates, it follows that the time interval in which said data packet is formed is equal to t₂−t₁; said time interval has same value and remains such over time for all the data packets and for each of the one or more acquisition units;
all the acquisition units comprised in said seismic monitoring system are synchronized with each other; the function of clock generator is performed by the master acquisition unit;
the master acquisition unit indicates, to itself and to each of the one or more slave acquisition units, the initial instants for the formation of the data packets;
at the instant t₂ᵢ, at which the i-th data packet is completed, the i-th data packet and the last (most recent) N data packets formed by said acquisition unit immediately before the i-th data packet are present in the RAM memory of each acquisition unit, N being a predetermined integer;
in each acquisition unit, each data packet comprises a set of data groups; each data group relates to one of the one or more components of the acceleration measured by one of the accelerometric sensors connected to the considered acquisition unit; the number of data groups comprised in a generic data packet is therefore equal to the number of the accelerometric sensors connected to the considered acquisition unit multiplied by the number of the components of the acceleration measured by each of said accelerometric sensors;
each acquisition unit, after having formed the i-th data packet, proceeds with the formation of the subsequent data packet and processes the data of said i-th data packet; in particular, it processes the data of each of said data groups comprised in said i-th data packet in order to identify whether at least one of said data groups is to be considered critical;
if all said data groups comprised in said i-th data packet result non-“critical”, said acquisition unit does not store, in its mass memory, the data of said i-th data packet; if even only one of said data groups, being part of said i-th data packet, results critical, said acquisition unit stores, in its mass memory, the data contained in said i-th data packet which is identified as “critical data packet”;
said acquisition unit also stores, in its mass memory, the N data packets present in the RAM memory thereof that were previously formed; said N data packets are those immediately preceding said critical data packet;
in addition, said acquisition unit communicates, in real time, the presence of said critical data packet to each of the other one or more acquisition units;
each of said other one or more acquisition units stores, in its mass memory, the i-th data packet formed thereby (said i-th data packet is simultaneous with said critical data packet) and also stores, in its mass memory, the previously formed data packets present in the RAM memory thereof;
each of the acquisition units comprised in said seismic monitoring system continues to store, in its mass memory, all the data transmitted by the accelerometric sensors connected thereto and continues to form the data packets and to process the data of each of said data packets in order to identify the critical data packets; each of said acquisition unit interrupts the storage of the data in its mass memory only after a predetermined time interval has passed (equal to J times the time interval in which each data packet is formed) during which none of the acquisition units comprised in said seismic monitoring system have detected a critical data packet, J being a predetermined integer.

19. The method according to claim 11, wherein each of the one or more acquisition units, during the examination of each data packet, calculates the effective value of each of the data groups comprised in said data packet; for each data group, the calculated effective value is compared with a predetermined threshold value (RMS threshold value); if the effective value of the examined data group is greater than said threshold value, then said data group is considered critical; said acquisition unit also identifies as “critical” the data packet to which said critical data group belongs.

20. The method according to claim 11, wherein each of the one or more acquisition units, during the examination of each data packet, calculates the peak—peak value of each of the data groups comprised in said data packet; for each data group, the calculated peak—peak value is compared with a predetermined threshold value (peak—peak threshold value); if the peak—peak value of the examined data group is greater than said threshold value, then said data group is considered critical; said acquisition unit also identifies as “critical” the data packet to which said critical data group belongs.

21. The method according to claim 11, wherein each of the one or more acquisition units stores, in the extractable mass memory thereof, all the data measured by the accelerometric sensors connected thereto.
